(19) United States
(12) Patent Application Publication
(10) Pub. No.: US 2023/0104325 A1
(43) Pub. Date: Apr. 6, 2023

(54) ADHESIVE TAPE WITH CROSSLINKED POLYURETHANE CARRIER

(71) Applicant: tesa SE, Norderstedt (DE)

(72) Inventors: Franziska Czerwonatis, Hamburg (DE); Leonie Pitzer, Hamburg (DE)

(73) Assignee: tesa SE, Norderstedt (DE)

(21) Appl. No.: 17/896,308

(22) Filed: Aug. 26, 2022

(30) Foreign Application Priority Data
Sep. 16, 2021 (DE) 10 2021 210 261.1

(51) Int. Cl. C09J 7/38; C09J 7/25; C09J 7/26

(52) U.S. Cl. CPC C09J 7/387; C09J 7/25; C09J 7/26; C09J 2203/326; C09J 2301/124; C09J 2301/302; C09J 2301/502; C09J 2400/243; C09J 2453/00; C09J 2475/006

(57) ABSTRACT

The present invention relates to a redetachable adhesive tape having a carrier based on a crosslinked polyurethane and an adhesive layer based on vinylaromatic block copolymer, to a method for producing the adhesive tape and the use of the adhesive tape in the production of electronic components.

The present invention relates to a redetachable adhesive tape having a carrier based on a crosslinked polyurethane and an adhesive layer based on vinylaromatic block copolymer, to a method for producing the adhesive tape and the use of the adhesive tape in the production of electronic components.

Redetachable adhesive tapes are long-established in the market and known to the skilled person.

Thus, EP 0 816 459 describes adhesive film strips for re-releasable bonding, having a layer construction composed of an elastic carrier layer, provided on one or both sides with a layer of adhesive, where both the carrier layer and the layer(s) of adhesive comprise, as base polymers, styrene block copolymers blended with tackifier resins which are compatible with the elastomer block of the styrene block copolymers used, these strips being detachable without damage and without residue by pulling in the direction of the bond plane.

DE 10 2015 206 076 relates to an adhesive strip composed of one or more adhesive layers all consisting of a pressure sensitive adhesive foamed with microballoons, the strip being redetachable without residue or destruction by extensive stretching substantially in the bond plane. DE 10 2016 223 852 discloses a pressure sensitive adhesive strip comprising at least one adhesive layer which is foamed with microballoons and at least one carrier B, which is redetachable without residue or destruction by extensive stretching substantially in the bond plane.

Redetachable adhesive tapes have more recently made gains in the electronics industry as well, where they are used for bonding components in electronic devices. A difficulty arising here, however, is that a balance must be found between sufficient peel adhesion and adhesive tape redetachability, in order to prevent damage to the components, which in some instances are sensitive, when the adhesive tape is redetached.

WO 2015/135134 describes an adhesive tape which is detachable by stretching and which comprises a carrier and a first layer of a pressure sensitive adhesive applied on at least one surface of the carrier, the adhesive tape having a thickness of between 0.05 and 0.1 mm and a lengthwise elongation of 850% to 2200%, the adhesive tape being firmly joined to a substrate and being redetachable therefrom by being able to be peeled from the surface of the substrate at an angle of 90° or more without tearing and without leaving any substantial residue on the substrate, the pressure-sensitive adhesive being formed from an acrylate copolymer which contains terminal functional polyurethane groups. The adhesive tape is said to be usable in electronic devices as well.

While the adhesive tapes in the prior art have proven suitable for electronic devices as well, they do have the disadvantage that in some cases large forces must be applied in order to remove the adhesive tapes, with the consequence that non-destructive parting from components bonded with the adhesive tapes cannot be ensured.

Against this background, the problem addressed by the present invention is that of providing an adhesive tape which can be redetached with a relatively low expenditure of force while at the same time having a sufficient peel adhesion to produce a robust bond between the components that are to be bonded.

It has surprisingly been found that this problem is solved by an adhesive tape as defined in Claim 1. Preferred developments of the adhesive tape of the invention are set out in the dependent claims.

A first subject of the present invention, therefore, is an adhesive tape releasable by stretching, comprising:
a) at least one carrier based on a crosslinked polyurethane; and
b) at least one pressure sensitive adhesive layer based on vinylaromatic block copolymer.

Within the present invention it has surprisingly been found that the adhesive tape of the invention goes against the existing prejudice that the crosslinking of the carrier reduces its stretchability and increases the force which must be expended in order to detach the adhesive tape. This effect has not been observed with the adhesive tapes of the invention. It has instead been found that the adhesive tapes of the invention exhibit a consistently low tensile strength during the detachment procedure at the same time as an increased maximum elongation and maximum breaking force, meaning that the force required to detach the adhesive tapes is low and at the same time few tears or none in the adhesive tapes were observed in application tests.

The present invention concerns adhesive tapes which may be present in any made-up forms, with preference being given to adhesive tape rolls. The adhesive tapes, especially in web form, may be produced either in the form of rolls, i.e. in the form of Archimedean spirals wound up onto themselves, or as adhesive strip, of the kind obtained for example in the form of diecuts.

The adhesive tapes of the invention are present more particularly in web form. A web refers to an object whose length (extent in x-direction) is greater by a multiple than its width (extent in y-direction) and the width is approximately consistent, preferably exactly consistent, along the entire length.

The general expression “adhesive tape”, and synonymously “adhesive strip”, as well, encompasses, in the sense of this invention, all sheetlike structures, such as two-dimensionally extended films or film sections, tapes with extended length and limited width, tape sections and the like and also, lastly, diecuts or labels.

The adhesive tapes have a longitudinal extent (x-direction) and a latitudinal extent (y-direction). The adhesive tapes also have a thickness (z-direction) which runs perpendicular to the two extents, with the latitudinal extent and longitudinal extent being greater by a multiple than the thickness. The thickness is very largely the same, preferably exactly the same, over the entire superficial extent of the adhesive tapes, this extent being defined by length and width.

The external, exposed faces of the pressure sensitive adhesive layers of the adhesive tapes of the invention may advantageously be equipped with non-stick materials such as a release paper or a release film, also called liners. A liner may also be a material with non-stick coating on at least one side, preferably both sides, such as double-sidedly siliconized material, for example. A liner or, formulated more generally, a temporary carrier is not part of an adhesive tape, but merely a means for its production, storage and/or further processing by diecutting. Furthermore, unlike a permanent carrier, a liner is not fixedly joined to a layer of adhesive, but instead functions as a temporary carrier, i.e. as a carrier which is removable from the layer of adhesive. In the present application, “permanent carriers” are also, simply and synonymously, called “carriers”.

Since the adhesive tapes of the invention comprise pressure sensitive adhesives, the adhesive tapes of the invention are also referred to as pressure sensitive adhesive tapes.

As described, the adhesive tapes of the invention can be redetached without residue or destruction by stretching. “Detached without residue”, applied to the adhesive tapes, means in accordance with the invention that they do not leave behind any residues of adhesive on the bonded surfaces of the components on detachment. Furthermore, “detachment without destruction” of the adhesive tapes means, in accordance with the invention, that they do not damage — destroy, for example — the bonded surfaces of the components on detachment.

### A) Carrier

The carrier used by the pressure sensitive adhesive tape of the invention is a carrier based on a crosslinked polyurethane. This polyurethane-based carrier is preferably a polyurethane prepared from extrusion (TPU) or a polyurethane prepared from dispersion (PUD). The polyurethane carrier may also have been prepared from solution.

The carrier preferably has a ratio of force at 400% extension F_{400%}, to the breaking force F_{break}, of at most 45%, preferably at most 40%.

The crosslinker is present preferably in an amount of 0.5 to 10 wt%, more preferably 1.0 to 8 wt%, more particularly 1.5 to 5 wt%, based on the total weight of the carrier.

The carrier layer of the invention has suitable mechanical properties for use in an adhesive tape detachable by extensive stretching. The carrier layer preferably has an elongation at break in longitudinal direction of at least 600%, more preferably at least 800%.

The carrier layer may be opaque, coloured, optically clear or transparent.

### i) Thermoplastic Polyurethane (TPU)

In a first embodiment the carrier of the adhesive tape comprises at least one, preferably exactly one, layer based on crosslinked thermoplastic polyurethane, having been produced typically by means of extrusion. A layer of this kind based on thermoplastic polyurethane typically means a layer with a fraction of thermoplastic polyurethane of at least 50 wt%. The fraction of thermoplastic polyurethane in the layer is preferably at least 90 wt%, and more particularly the layer consists substantially of thermoplastic polyurethane.

The crosslinked thermoplastic polyurethane of the at least one carrier layer is preferably polyester-based, but may alternatively also be polyether-based, such as based, for example, on poly THF as polyol. The polyester-based or polyether-based thermoplastic polyurethane is typically thermoplastic polyurethane based on aliphatic polyester or aliphatic polyether, respectively. The glass transition temperature (T_{g}) of the soft molecular chain of the thermoplastic polyurethane is preferably between -20° C. and 40° C., and the glass transition temperature of the hard molecular chain of the thermoplastic polyurethane is preferably between 60 to 110° C. The thermoplastic polyurethane typically has a tensile strength of more than 20, preferably more than 35 MPa and the Shore hardness A is preferably between 55 and 85, such as more particularly between 55 and 70. In an alternatively preferred embodiment, the Shore hardness is between 70 and 85.

The thermoplastic polyurethane is preferably a reaction product of a reaction mixture which comprises at least one diisocyanate, at least one polyester polyol (or polyether polyol), a crosslinker and optionally at least one chain extender, the polyester polyol or polyether polyol typically having a melting temperature of at least 30° C., such as, for example, at least 100° C. or at least 200° C. The choice of a suitable processing operation, such as of the cooling conditions, for example, may contribute to increasing the degree of crystallization of the layer. The degree of crystallinity may be determined by Differential Scanning Calorimetry (DSC) and is expressed as a fraction of the crystallinity in the thermoplastic polyurethane film.

The fraction of diisocyanate in the reaction mixture is preferably 0.5 to 47 wt%, more preferably 1 to 40 wt% and more particularly 10 to 25 wt%. The amount of the diisocyanate in the reaction mixture may also be expressed as the isocyanate index. An isocyanate index is understood generally to refer to the ratio of the equivalent amount of the functional isocyanate groups used to the equivalent amount of the functional hydroxy groups. The isocyanate index of the reaction mixture is preferably in a ratio from 0.99 to 1.20, such as 1.00 to 1.10.

The diisocyanate is preferably a diisocyanate having the structure according to Formula I

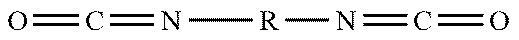

in which R is selected from substituted or unsubstituted (C₁-C₄ₒ)-alkylene, (C₂-C₄₀)-alkenylene, (C₄-C₂₀)-arylene, (C₄-C₂₀)-arylene-(C₁-C₄₀)-alkylene-(C₄-C₂₀)-arylene, (C₄-C₂₀)-cycloalkylene and (C₄-C₂₀)-aralkylene. In further examples the diisocyanate is selected from dicyclohexylmethane 4,4'-diisocyanate, isophorone diisocyanate, hexamethylene diisocyanate, 1,4-phenylene diisocyanate, 1,3-phenylene diisocyanate, m-xylylene diisocyanate, tolylene 2,4-diisocyanate, toluene 2,4-diisocyanate, tolylene 2,6-diisocyanate, poly(hexamethylene diisocyanate), 1,4-cyclohexylene diisocyanate, 4-chloro-6-methyl-1,3-phenylene diisocyanate, hexamethylene diisocyanate, diphenyl methane-4,4'-diisocyanate, 1,4-diisocyanatobutane, 1,8-diisocyanatooctane, 2,6-toluene diisocyanate, 2,5-toluene diisocyanate, 2,4-toluene diisocyanate, m-phenylene diisocyanate, p-phenylene diisocyanate, methylenebis(o-chlorophenyl diisocyanate), methylenediphenylene 4,4'-diisocyanate, (4,4'-diisocyanato-3,3',5,5'-tetraethyl)diphenylmethane, 4,4'-diisocyanato-3,3'-dimethoxy-biphenyl(o-dianisidine diisocyanate), 5-chloro-2,4-toluene diisocyanate, 1-chloromethyl-2,4-diisocyanatobenzene, tetramethyl-m-xylylene diisocyanate, 1,6-diisocyanatohexane, 1,12-diisocyanatododecane, 2-methyl-1,5-diisocyanatopentane, methylenedicyclohexylene 4,4'-diisocyanate, 3-isocyanatomethyl-3,5,5-trimethylcyclohexyl isocyanate, 2,2,4-trimethylhexyl diisocyanate or a mixture thereof.

A particularly preferred diisocyanate is diphenylmethane 4,4'-diisocyanate (MDI), hexane diisocyanate (HDI), isophorone diisocyanate (IPDI) or hexamethylene diisocyanate (HMDI). The fraction of polyester polyol or polyether polyol in the reaction mixture is preferably in the range from 43 wt% to 70 wt%, more preferably 50 wt% to 60 wt%.

The polyester polyol may contain an arbitrary suitable number of hydroxyl groups. The polyester polyol may for example contain four hydroxyl groups or three hydroxyl groups. The polyester polyol may even contain two hydroxyl groups, so making the polyester polyol a polyester diol. In general the polyester polyol may be a product of a condensation reaction such as a polycondensation reaction. The polyester polyol, however, is typically not prepared via a ring-opening polymerization reaction product.

In examples in which polyester polyol is prepared by a condensation reaction, the reaction may take place between one or more carboxylic acids and one or more polyols. Examples of suitable carboxylic acids include carboxylic acids of formula IIa (dicarboxylic acids) and IIb (hydroxycarboxylic acids) with the following structures:

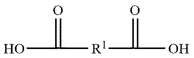

In the formula IIa, R¹ is typically selected from substituted or unsubstituted (C₁-C₄ₒ)-alkylene, (C₂-C₄₀)-alkenylene, (C₄-C₂₀)-arylene, (C₄-C₂₀)-cycloalkylene and (C₄-C₂₀)-aralkylene.

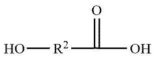

In the formula IIb R² is typically selected from substituted or unsubstituted (C₁-C₄ₒ)-alkylene, (C₂-C₄₀)-alkenylene, (C₄-C₂₀)-cycloalkylene and (C₄-C₂₀)-aralkylene.

Examples of suitable carboxylic acids include lactic acid (2-hydroxypropanoic acid), succinic acid (butanedioic acid), 3-hydroxybutanoic acid, 3-hydroxypentanoic acid, terephthalic acid (benzene-1,4-dicarboxylic acid), naphthalene dicarboxylic acid, 4-hydroxybenzoic acid, 6-hydroxynaphthalene-2-carboxylic acid, oxalic acid, malonic acid (propanedioic acid), adipic acid (hexanedioic acid), pimelic acid (heptanedioic acid), ethoic acid, suberic acid (octanedioic acid), azelaic acid (nonanedioic acid), sebacic acid (decanedioic acid), glutaric acid (pentanedioic acid), dodecanoic acid, brassylic acid, thapsic acid, maleic acid, fumaric acid, glutaconic acid, 2-decenoic acid, muconic acid, glutinic acid, citraconic acid, mesaconic acid, itaconic acid, malic acid (2-hydroxybutanedioic acid), aspartic acid (2-aminobutanedioic acid), glutaminic acid (2-aminopentanedioic acid), tartaric acid (2,3-dihydroxybutanedioic acid), diaminopimelic acid, saccharic acid, mesoxalic acid, oxalacetic acid, acetonedicarboxylic acid (3-oxopentanedioic acid), arabinaric acid, phthalic acid, isophthalic acid, 2,6-naphthalenedicarboxylic acid or a mixture thereof. Adipic acid is particularly preferred.

One example of a suitable polyol comprises a polyol of formula III having the structure:

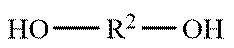

In the formula III, R² is selected from substituted or unsubstituted (C₁-C₄ₒ)-alkylene, (C₂-C₄₀)-alkenylene, (C₄-C₂₀)-arylene, (C₁-C₄₀)-acylene, (C₄-C₂₀)-cycloalkylene, (C₄-C₂₀)-aralkylene and (C₁-C₄₀)-alkoxylene.

The diol may for example have a weight-average molecular weight in a range from 30 daltons to 250 daltons, preferably 50 daltons to 150 daltons. The diol component may contain an arbitrary suitable number of carbons. The diol may for example have a number-average number of 2 carbons to 50 carbons, preferably 3 carbons to 140 carbons. Examples of suitable diols include ethylene glycol, diethylene glycol, triethylene glycol, tetraethylene glycol, propylene glycol, dipropylene glycol, tripropylene glycol, 1,3-propanediol, 1,3-butanediol, 1,4-butanediol, neopentyl glycol, 1,6-hexanediol, 1,4-cyclohexanedimethanol or a mixture thereof.

Particularly preferred polyester polyols accordingly are polyalkylene adipates.

Conventionally employed for film production is, primarily, the blown film operation involving multiple layers. In this case a PE layer (i.e. polyethylene layer) and the actual TPU layer are produced as a coextruded film in a blown film operation (that is, the PE layer functions as a supporting carrier, providing the extrudate with the required mechanical stability). In use, i.e. before the production of the adhesive tape, the PE support carrier is removed, meaning that it represents a temporary carrier. For the production of a corresponding blown film, however, numerous additives are required, such as antiblocking agents (e.g. silica particles) and lubricating waxes, in order to prevent blocking of the PU film when the bubble is collapsed in the blown film operation. The problem here is that TPUs after melting are still tacky for about 1 h. Both facts (crystalline superstructure and additives, especially silica particles) lead to an adverse effect on the mechanical properties. Both the silicate particles in the film (point defects) and the crystalline superstructure (hard, inflexible domains) result in a reduction in stretchability and, in particular, in a greater tearing tendency in use, i.e. on extensive stretching. As a result of migration of the waxes to the PSA surface, i.e. the surface of the pressure sensitive adhesive, the waxes lead additionally to problems with peel strength reduction and also to difficulties with the anchoring of the PSA on the film. Additionally advantageous for high stretchability and low tearing tendency, is a high molecular weight of the PU polymer, to increase the toughness of the film.

The TPU-based carrier layer is therefore preferably free from additives such as antiblocking agents and waxes. Preferably, moreover, the polyurethane does not have a crystalline superstructure, as manifested in a DSC peak > 210° C.

In one preferred embodiment the TPU-based carrier layer is foamed. Foaming takes place preferably with microballoons. Suitable microballoons are described later on below. It is also possible, alternatively, to use chemical and/or physical blowing agents.

### ii) Polyurethane Obtained by Dispersion (PUD)

In an alternatively preferred embodiment, the carrier of the adhesive tape of the invention comprises at least one, preferably exactly one, layer based on crosslinked polyurethane which has been produced on a dispersion with a crosslinker. A layer of this kind based on polyurethane typically refers to a layer with a polyurethane fraction of at least 50 wt%. The fraction of polyurethane in the layer is preferably at least 90 wt%. The polyurethane is typically thermoplastic.

The polyurethane is composed more particularly of at least one polyisocyanate component and at least one polyol component, hence being the reaction product of at least the stated components.

The polyurethane here is more preferably aliphatic polyester-polyurethane or aliphatic polyether-polyurethane; that is, the polyurethane in this case is based on aliphatic polyester or aliphatic polyether.

The at least one polyisocyanate component is preferably a diisocyanate. Use may be made of aromatic diisocyanates such as toluene diisocyanate (TDI) (particularly preferred), p-phenylene diisocyanate (PPDI), 4,4'-diphenylmethane diisocyanate (MDI), p,p'-bisphenyl diisocyanate (BPDI), or, in particular aliphatic diisocyanates, such as isophorone diisocyanate (IPDI), 1,6-hexamethylene diisocyanate (HDI), or 4,4'-diisocyanatodicyclohexylmethane (H12MDI). Likewise suitable are diisocyanates having substituents in the form of halo-, nitro-, cyano-, alkyl-, alkoxy-, haloalkyl-, hydroxyl-, carboxy-, amido-, amino- or combinations thereof.

Overall it is possible for all isocyanates to be used that are known per se and are aliphatic, cycloaliphatic, araliphatic and, preferably, the aromatic polyfunctional isocyanates.

Specific examples include the following: alkylene diisocyanates having 4 to 12 carbon atoms in the alkylene radical, such as 1,12-dodecane diisocyanate, 2-ethyltetramethylene 1,4-diisocyanate, 2-methyl-pentamethylene 1,5-diisocyanate, tetramethylene 1,4-diisocyanate, and preferably hexamethylene 1,6-diisocyanate; cycloaliphatic diisocyanates such as cyclohexane 1,3-diisocyanate and cyclohexane 1,4-diisocyanate and any desired mixtures of these isomers, 1-isocyanato-3,3,5-trimethyl-5-isocyanatomethylcyclohexane (isophorone diisocyanate), 2,4- and 2,6-hexahydrotolylene diisocyanate and also any desired mixtures of these isomers, 4,4'-, 2,4'- and 2,2'-dicyclohexylmethane diisocyanate and any desired mixtures of these isomers, and preferably aromatic di- and polyisocyanates, such as, for example, 2,4-and 2,6-tolylene diisocyanate and the corresponding isomer mixtures, 4,4'-, 2,4'- and 2,2'-diphenylmethane diisocyanate and the corresponding isomer mixtures, mixtures of 4,4'- and 2,4'-diphenylmethane diisocyanates, polyphenyl-polymethylene polyisocyanates, mixtures of 4,4'-, 2,4'- and 2,2'-diphenylmethane diisocyanates and polyphenyl-polymethylene polyisocyanates (crude MDI), and mixtures of crude MDI and tolylene diisocyanates. The organic di- and polyisocyanates may be used individually or in the form of their mixtures.

The polyisocyanate component preferably has a number-average molecular weight of 60 to 50 000 g/mol, more particularly of 400 to 10 000 g/mol, preferably of 400 to 6000 g/mol.

Use is also frequently made of what are called modified polyfunctionalized isocyanates, these being products obtained by chemical reaction of organic di- and/or polyisocyanates. Examples include di- and/or polyisocyanates containing ester, urea, biuret, allophanate, carbodiimide, isocyanurate, uretdione and/or urethane groups. Specific examples contemplated include the following: organic, preferably aromatic polyisocyanates containing urethane groups and having NCO contents of 33.6 to 15 wt%, preferably of 31 to 21 wt%, based on their total weight. Examples are 2,4- and/or 2,6-tolylene diisocyanate or crude MDI modified with low molecular weight diols, triols, dialkylene glycols, trialkylene glycols or polyoxyalkylene glycols having number-average molecular weights up to 6000 g/mol, more particularly up to 1500 g/mol. Examples of suitable di- and polyoxyalkylene glycols are diethylene, dipropylene, polyoxyethylene, polyoxypropylene and polyoxypropylene-polyoxyethylene glycols, triols and/or tetrols. Also suitable are prepolymers containing NCO groups with NCO contents of 25 to 3.5 wt%, preferably of 21 to 14 wt%, based on the total weight, prepared from polyester polyols and/or preferably polyether polyols and 4,4'-diphenylmethane diisocyanate, mixtures of 2,4'- and 4,4'-diphenylmethane diisocyanate, 2,4- and/or 2,6-tolylene diisocyanate or crude MDI. Additionally having proven to be useful are liquid polyisocyanates containing carbodiimide groups and/or isocyanurate rings and having NCO contents of 33.6 to 15 wt%, preferably 31 to 21 wt%, based on the total weight, these polyisocyanates being based for example on 4,4'-, 2,4'- and/or 2,2'-diphenylmethane diisocyanate and/or 2,4- and/or 2,6-tolylene diisocyanate.

The modified polyisocyanates may be mixed with one another or with unmodified organic polyisocyanates such as, for example, 2,4'-, 4,4'-diphenylmethane diisocyanate, crude MDI, 2,4- and/or 2,6-tolylene diisocyanate.

Particularly proven as isocyanates are diphenylmethane diisocyanate isomer mixtures or crude MDI and especially crude MDI having a diphenylmethane diisocyanate isomer content of 30 to 55 wt%, and also polyisocyanate mixtures containing urethane groups which are based on diphenylmethane diisocyanate with an NCO content of 15 to 33 wt%.

Preferred weight fractions of the polyisocyanate component are from 10 to 40 wt%, more particularly 13 to 35 wt% and very preferably 15 to 30 wt%.

A polyol component in the invention means not only polymers having at least two hydroxyl groups, but instead, generally, compounds having at least two hydrogen atoms that are active with respect to isocyanates.

The polyol component is preferably a diol, a polyether diol, a polyester diol, a polycarbonate diol, a polycaprolactone polyol or a polyacrylate polyol, more preferably polyether diol, polyester diol and polycarbonate diol, and more particularly glycol, propanediol, butanediol, pentanediol, hexanediol, cyclohexanediol, cyclohexyldimethanol, octanediol, neopentyl glycol, diethylene glycol, triethylene glycol, trimethylpentanediol, benzenedimethanol, benzenediol, methylbenzenediol, bisphenol A, poly(butanediol-co-adipate)glycol, poly(hexanediol-co-adipate)glycol, poly(ethanediol-co-adipate)glycol, polytetramethylene glycol, polypropylene glycol, polyethylene glycol, or a mixture thereof.

The principal function of the polyol component is to react with the polyisocyanate component to give the polyurethane polymer. In addition, however, the polyol component also serves as a physical conditioner, since the elasticity of the polyurethane is dependent on the molecular weight of the polyol component. The general rule is that the higher the molecular weight of the polyol component, the softer the resulting polyurethane.

The polyol component preferably has a number-average molecular weight of 60 to 50 000 g/mol, more particularly of 400 to 10 000 g/mol, preferably of 400 to 6000 g/mol.

Polyurethane dispersions which may be employed for the purposes of the present invention include in particular the following dispersions, optionally in combination:
a) anionically stabilized aliphatic polyester-polyurethane dispersions (dispersions based on polyester and aliphatic anionic isocyanate-polyurethane). These include the following products sold by Covestro AG: Impranil® LP RSC 1380, DL 1537 XP, DL 1554 XP; from Lanxess Witcobond 373-04; or from Stahl, PERMUTEX® RU-92-410
b) anionically stabilized aliphatic polyether-polyurethane dispersions. These include the following products sold by Covestro AG: Impranil® 25 LP DSB 1069; or, from Lanxess, Witcobond 386-53
c) anionically stabilized aliphatic polycarbonate-polyester-polyurethane dispersions. These include the following products sold by Covestro AG: Impranil® DLU; or, from Stahl, Permutex® EX-RU-92-600
d) anionically stabilized polycarbonate-polyurethane dispersions. These include the following products sold by Covestro AG: Impranil® DL 2288 XP.

The polyurethane dispersions here have a high solids fraction of preferably 30 to 70 wt%, more preferably 50 to 60 wt%. All of the products stated above under a) to d) are typically free from organic cosolvents.

The polyurethane dispersions of the present invention are aqueous. They are preferably free from organic solvents, but may optionally include organic solvents.

To adjust the properties of the polyurethane carrier under production it may be advantageous for the starting mixture to include, additionally, at least one further dispersion, typically selected from the group consisting of polyurethane dispersions, polyurethane dispersions whose polyol component comprises a comonomer with flame retardant effect, synthetic rubber dispersions, natural rubber dispersions and polyacrylate dispersions. In this way it is possible to adjust parameters including the stability of the polyurethane carrier and its elongation at break.

Polyacrylate dispersions comprise water-insoluble polyacrylate, typically dispersed in water by means of an emulsifier. They contain, for example, about 30 to 60 wt% polyacrylate and about 3 wt% emulsifier. The polyacrylate in the invention is a water-insoluble polyacrylate, polymethacrylate, mixtures thereof or copolymers with other monomers. The emulsifier may be an ionic, nonionic or steric emulsifier. It is normally not incorporated fixedly into the polymer chains. Acrylate dispersions may comprise further additives, such as film formers or cosolvents, defoamers, flame retardants and/or wetting agents.

Acrylate dispersions are typically obtained by the emulsion polymerization of suitable monomers. For this purpose these monomers are finely dispersed in water using an emulsifier. To emulsify the monomers in water, a water-soluble radical initiator is added. Because the radicals formed from this initiator dissolve preferentially in the water, their concentration in the monomer droplets is low, allowing the polymerization to proceed very uniformly in the droplets. After the end of the polymerization, the dispersion can be used directly, but is often admixed with additives such as defoamers, film formers and/or wetting agents in order to achieve a further improvement in the properties.

The reaction of the OH groups of the polyol component with the isocyanate groups may optionally be catalysed. Catalysts contemplated include in particular the following:

Organometallic compounds, preferably organic tin compounds, such as tin(II) salts of organic carboxylic acids, examples being tin(II) acetate, tin(II) octoate, tin(II) ethylhexanoate, tin(II) laurate and the dialkyltin(lV) salts of organic carboxylic acids, examples being dibutyltin diacetate, dibutyltin dilaurate, dibutyltin maleate, dioctyltin diacetate, and also tertiary amines such as triethylamine, tributylamine, dimethylcyclohexylamine, dimethylbenzylamine, N-methylimidazole, N-methyl-, N-ethyl-, N-cyclohexylmorpholine, N,N,N',N'-tetramethylethylenediamine, N,N,N',N'-tetramethylbutylenediamine, N,N,N',N'-tetramethylhexylene-1,6-diamine, pentamethyldiethylenetriamine, tetramethyldiaminoethyl ether, bis(dimethylaminopropyl)urea, dimethylpiperazine, 1,2-dimethylimidazole, 1-azabicyclo-[3.3.0]-octane, 1,4-diazabicyclo[2.2.2]octane, and additionally alkanolamine compounds such as triethanolamine, tris-isopropanolamine, N-methyl- and N-ethyldiethanolamine and dimethylethanolamine.

Catalysts contemplated further include: tris(dialkylamino)-s-hexahydrotriazines, more particularly tris-(N,N-dimethylamino)-s-hexahydrotriazine, tetraalkylammonium salts such as, for example, N,N,N-trimethyl N-(2-hydroxypropyl)formate, N,N,N-trimethyl-N-(2-hydroxypropyl)-2-ethylhexanoate, tetraalkylammonium hydroxides such as tetramethylammonium hydroxide, alkali metal hydroxides such as sodium hydroxide, alkali metal alkoxides such as sodium methoxide and potassium isopropoxide, and also alkali metal or alkaline earth metal salts of fatty acids having 1 to 20 carbon atoms and optionally pendent OH groups.

Preference is given to using tertiary amines, tin compounds, alkali metal and alkaline earth metal carboxylates, quaternary ammonium salts, s-hexahydrotriazines and tris(dialkylaminomethyl)phenols.

Preference is given to using 0.001 to 5 wt%, more particularly 0.002 to 2 wt%, of catalyst or catalyst combination, based on the total weight of the starting mixture.

The polyurethane may optionally comprise a component containing active hydrogen and able to form a hydrophilic group, specifically with preference from 1 to 15 wt%, more particularly from 3 to 10 wt% and very preferably from 4 to 7 wt%. “Active hydrogen” here means that the hydrogen atom of the component is unstable in the sense that it is readily able to undergo a chemical reaction, such as a substitution reaction, with other compounds, so that a hydrophilic group may form. The effect of this component is that the polyurethane can be dispersed efficiently in water. Particularly suitable hydrophilic groups include the following: -COO⁻,-SO₃⁻, —NR₃⁺, or —(CH₂CH₂O)ₙ—. The component containing active hydrogen may be, for example: dimethylolpropionic acid (DMPA), dimethylolbutyric acid (DMBA), polyethylene oxide, bis(hydroxyethyl)amines or sodium 3-bis(hydroxyethyl)aminopropanesulfonate.

The component containing active hydrogen is optional, as described above. For the purpose of dispersing, the polyurethane dispersion additionally or alternatively often includes at least one surfactant.

Particularly suitable surfactants, which also act as a foam stabilizer, include especially Stokal® STA (ammonium stearate) and Stokal® SR (succinamate) from Bozzetto Group.

Also contemplated, however, are further surfactants, which in particular may be selected from the group consisting of ether sulfates, fatty alcohol sulfates, sarcosinates, organic amine oxides, sulfonates, betaines, amides of organic acids, sulfosuccinates, sulfonic acids, alkanolamides, ethoxylated fatty alcohols, sorbinates and combinations thereof.

As a further optional component, the starting mixture may comprise a thickener. In this case it is possible for example to use Borchi® Gel 0625. Further suitable thickeners include polyetherurethane solutions such as Ortegol PV301 from Evonik Industries, for example. A thickener in particular ensures stability on drying.

The starting mixture may comprise further additives such as stabilizers, including light stabilizers. Solvents as well may be added as further additives. Suitable solvents are those customary in the production of polyurethane materials, such as ketones, e.g. acetone, alkyl carboxylates, such as methyl acetate, alkyl carbonates, or amides, such as DMF, or additional liquid flame retardants such as alkyl phosphates, for example triethyl phosphate or tributyl phosphate, halogenated alkyl phosphates such as tris-(2-chloropropyl) phosphate or tris(1,3-dichloropropyl) phosphate, aryl phosphates such as diphenyl cresyl phosphate and phosphonates such as diethyl ethanephosphonate, for example. Likewise employable are mixtures of the stated solvents.

Further optional additives are cell regulators of the type known per se, such as paraffins or fatty alcohols or dimethylpolysiloxanes, flame retardants, pigments or dyes, stabilizers against effects of ageing and weathering, plasticizers, fungistatic and bacterostatic substances, fillers such as barium sulfate, bentonite, kaolin, glass powder, glass beads, glass fibres, calcium carbonate, kieselghur, quartz sand, fluoropolymers, thermoplastics, microbeads, expandable graphite, carbon black or suspended chalk or combinations thereof.

In one preferred embodiment it is also possible to add expandable microballoons, which are expanded when the carrier composition is dried. An alternative possibility is to add pre-expanded microballoons. Suitable microballoons are described below.

The foaming in the case of the carrier of the invention based on polyurethane produced from a dispersion may be achieved by frothing. The process typically comprises the following steps:
a) introducing a polyurethane dispersion as described above and at least one surfactant, and optionally further components, such as further dispersions in particular, to form a starting mixture,
b) mechanically foaming the starting mixture to form a moist polyurethane foam composition, optionally with addition of further components, such as especially fillers and/or further additives,
c) applying the moist polyurethane foam composition to a surface, preferably a temporary carrier, such as especially a liner, or a pressure sensitive adhesive layer,
d) drying the moist polyurethane foam composition to give the polyurethane foam.

To form the polyurethane foam, the starting mixture, i.e. the polyurethane dispersion prepared as above or in some other way, is beaten mechanically together with the at least one surfactant and also optionally a solvent and/or the further optional constituents, and is foamed. A thickener may optionally be added after beating has taken place.

Alternatively a prepolymer dispersion may be used, and the prepolymer polymerizes to the polyurethane in the course of the mechanical beating/foaming.

It is possible additionally or alternatively to add a physical blowing agent. Hence the starting mixture may be foamed, for example, in the presence of a gas such as air, nitrogen or a noble gas, for example helium, neon or argon. Blowing agents may be used individually or as a mixture of different blowing agents. Blowing agents may be selected from a large number of materials, including the following: hydrocarbons, ethers and esters and the like. Typical physical blowing agents have a boiling point in the range from -50° C. to +100° C., and preferably from -50° C. to +50° C. Preferred physical blowing agents include hydrocarbons such as n-pentane, isopentane and cyclopentane, methylene chloride, or any combinations of the aforementioned compounds. Such blowing agents may be used preferably in amounts of 5 wt% to 50 wt% of the reaction mixture, more particularly of 10 wt% to 30 wt% of the reaction mixture.

It is also possible additionally or alternatively to add a chemical blowing agent. Chemical blowing agents are substances that eliminate gas — and thereby enable the generation of a foam structure in the polymer— only during the processing operation, on the basis of a chemical reaction, usually initiated by supply of heat. The cause of the elimination of gas may either be the thermal decomposition of the blowing agent or a chemical reaction of various substances present in the blowing agent. The gas formed is usually N₂, CO₂ or CO.

Foamed carriers based on polyurethane preferably have a density of 250 kg/m³ to 500 kg/m³, more preferably 350 to 450 kg/m³.

A film may optionally be applied over the foam layer. The film, if it is under tension, may limit the thickness of the foam layer. The film may alternatively function merely as a cover.

In a further preferred embodiment, the foam may be applied to the temporary carrier, such as, in particular, the liner, and/or to the pressure sensitive adhesive layer, by means of a blade or knife, thereby achieving a uniform thickness of the foam layer, before it is brought or moved into the drying oven. Alternatively, rollers may also be provided in order to adjust the thickness of the foam layer.

Application of the foam layer of the carrier is followed by drying, preferably in a drying oven. Preferred temperatures for drying are from 50° C. to 180° C., preferably from 50° C. to 120° C., more particularly from 70° C. to 115° C., very preferably from 100° C. to 115° C. The temperature is preferably at least 50° C., more particularly at least 60° C., more preferably at least 70° C., more particularly at least 80° C., very preferably at least 90° C., more particularly at least 100° C., more particularly at least 110° C., very preferentially at least 120° C., more particularly at least 130° C. Additionally the temperature is preferably at most 180° C., more particularly at most 170° C., very preferably at most 160° C., more particularly at most 150° C.

The drying in step d) of the process sequence indicated above takes place preferably in at least two stages, with the drying temperature being increased from one step to the next. Unlike when using high starting temperatures (e.g. 120° C.) during the drying, a staged increase in the drying temperature enables uniform drying, leading to a uniform distribution of the cell sizes. At lower temperature there is at first relatively uniform initial drying of the entire foam, and in a further step at higher temperature the residual moisture is removed.

It may, however, also be desirable to achieve a cell size that varies over the cross section. In this case a high drying temperature should be employed from the start. This ensures that the foam dries rapidly at the surface, but remains moist for a long time in the interior, so resulting in the different cell size distribution over the cross section.

The drying in step d) takes place more preferably in two stages, with the drying temperature in the 1^{st} step being from 50° C. to 100° C., preferably 70° C. to 90° C., more particularly 80° C., and the drying temperature in the 2^{nd} step being from 105° C. to 180° C., preferably 110° C. to 150° C., more particularly 120° C.

The PU-based carrier layer from dispersion is preferably free from additives such as antiblocking agents and waxes. The polyurethane also preferably does not have a crystalline superstructure, for the reasons described above.

Moreover, the PU-based carrier layer from dispersion or the adhesive tape comprising this layer, may preferably be subjected to a heat treatment at not less than 150° C. in order to optimize the tensile strength.

### iii) Microballoons

“Microballoons” are understood to be hollow microbeads that are elastic and hence expandable in their ground state, having a thermoplastic polymer shell. These beads are filled with low-boiling liquids or liquefied gas. Shell material used is, in particular, polyacrylonitrile, PVDC, PVC or polyacrylate. Suitable low-boiling liquids are, in particular, hydrocarbons of the lower alkanes, for example isobutane or isopentane, which are enclosed as a liquefied gas under pressure in the polymer shell.

Action on the microballoons, especially as a result of heat exposure, causes the outer polymer shell to soften. At the same time the liquid blowing gas within the shell is converted to its gaseous state. The microballoons at this point undergo irreversible extension and three-dimensional expansion. The expansion is at an end when the internal and external pressures are in balance. Since the polymeric shell is conserved, the result is a closed-cell foam.

A large number of types of microballoons are available commercially, and differ substantially in terms of their size, preferably 6 to 45 µm diameter in the unexpanded state, and in the starting temperatures they require for their expansion, preferably 75 to 220° C. One example of commercially available microballoons are the Expancel® DU products (DU = dry unexpanded) from Nouryon.

Unexpanded microballoon products are also available in the form of an aqueous dispersion having a solids or microballoon fraction of around 40 to 45 wt%, and also, furthermore, in the form of polymer-bound microballoons (masterbatches), for example in ethylene vinyl acetate, with a microballoon concentration of around 65 wt%. Like the DU products, both the microballoon dispersions and the masterbatches are suitable for production of a foamed pressure sensitive adhesive of the invention.

A foamed pressure sensitive adhesive of the invention may also be generated with what are called pre-expanded microballoons. With this group, the expansion takes place even prior to incorporation into the polymer matrix. Pre-expanded microballoons are available commercially for example under the Dualite® name or with the type designation Expancel xxx DE (dry expanded) from Nouryon.

The mean diameter of the voids formed by the microballoons in the foamed pressure sensitive adhesive layers, in accordance with the invention, is preferably 10 to 200 µm, more preferably from 15 to 200 µm. Since in this case it is the diameters of the voids formed by the microballoons in the foamed pressure sensitive adhesive layers that are measured, the diameters in question are the diameters of the voids formed by the expanded microballoons. The mean diameter here refers the arithmetic mean of the diameters of the voids formed by the microballoons in the pressure sensitive adhesive layer. The mean diameter of the voids formed by the microballoons in a pressure sensitive adhesive layer is determined using 5 different cryofracture edges of the adhesive tape under a scanning electron microscope (SEM) with 500 times magnification. The diameters of the microballoons visible in the micrographs are ascertained graphically such that the maximum extent of each individual microballoon in the pressure sensitive adhesive layer under study, in arbitrary (two-dimensional) direction, is taken from the SEM micrographs, and is regarded as the diameter of that microballoon.

Where foaming is carried out using microballoons, the microballoons can be supplied to the formulation as a batch, a paste or a blended or unblended powder. They may also be present in suspension in solvent.

The fraction of the microballoons in the adhesive according to one preferred embodiment of the invention is between greater than 0 wt% and 10 wt%, more particularly between 0.25 wt% and 5 wt%, very particularly between 0.5 and 1.5 wt%, based in each case on the overall composition of the adhesive. The figures refer to unexpanded microballoons.

A polymer composition of the invention which comprises expandable hollow microbeads may additionally include non-expandable hollow microbeads. The only crucial factor is that virtually all the gas-containing cavities are closed by a permanently impervious membrane, no matter whether this membrane consists of an elastic and thermoplastically stretchable polymer mixture or, for instance, of elastic glass which — within the spectrum of the temperatures possible in plastics processing — is non-thermoplastic.

Additionally suitable— chosen independently of other additives — are solid polymer beads, hollow glass beads, solid glass beads, hollow ceramic beads, solid ceramic beads and/or solid carbon beads (“carbon microballoons”).

### B) Crosslinker

In the invention the basis for the carrier is a polyurethane crosslinked with a crosslinker. According to prevailing opinion, the addition of a crosslinker raises the level of tensile strength while at the same time reducing the maximum stretchability of a polyurethane-based carrier. That would not ensure non-destructive detachment of the adhesive tape. Within the present invention it has surprisingly emerged that, contrary to the prevailing opinion, only the breaking force is increased, with the maximum stretchability virtually unchanged, with advantageous consequences for redetachability of the adhesive tape of the invention.

Crosslinkers are able to react essentially in two different ways: through reaction with a polymer, or through reaction with themselves to form what is called an interpenetrating network, which produces a far denser network and therefore improves numerous properties, such as strength, abrasion resistance, hydrolysis resistance and chemical resistance, for example.

Preferred crosslinkers in the context of the present invention are, in particular, crosslinkers based on aziridine, carbodiimide (polycarbodiimide), melamine, radical-forming substances, such as organic peroxides, sulfur and isocyanate. In one preferred embodiment the crosslinker is an isocyanate, preferably a blocked polyisocyanate, more particularly a blocked aliphatic polyisocyanate.

Polyisocyanates are able to react with functional groups such as amino or hydroxyl groups. The polyfunctionality of this type of crosslinker results in a 3D crosslinked network. Polyisocyanates react with water as well, which gives rise in turn to a reaction of the polyisocyanate molecules with themselves and results in a network which consists of a combination of conventional 3D polymer-crosslinked network and an interpenetrating network, brought about by the reactivity of multiple polyisocyanate molecules with themselves.

In the case of an isocyanate crosslinker, this is obtained preferably from a dispersion which comprises a polyisocyanate, a blocking agent for isocyanate groups, and water. In one preferred embodiment the dispersion for obtaining the crosslinker further comprises a polyamine, preferably one having at least one carboxyl and/or carboxylate group.

Polyisocyanates are considered presently to be compounds which have NCO groups. The polyisocyanate may have a number-average molecular weight of 140 to 1500 g/mol and preferably of 168 to 700 g/mol. According to one preferred embodiment of the invention, the polyisocyanate has an isocyanate functionality of > 2 and < 6, preferably of > 3 and < 5 and more preferably of > 3 and < 4.

The polyisocyanate preferably has an NCO group content of 15 to 30 wt%, more preferably of 18 to 25 wt% and very preferably of 20 to 24 wt%, based on the number-average molar weight of the polyisocyanate.

Suitable polyisocyanates, are for example, hexamethylene diisocyanate (HDI), isophorone diisocyanate (IPDI), 4,4'-diisocyanatodicyclohexylmethane (H₁₂MDI), 1,4-butane diisocyanate, hexahydrodiisocyanatotoluene, 1,3-bis(isocyanatomethyl)cyclohexane, hexahydrodiiso-cyanatoxylene, nonane triisocyanate. Particularly preferred is the use of isophorone diisocyanate, hexamethylene diisocyanate and/or 4,4'-diisocyanatodicyclohexylmethane.

Particularly preferred polyisocyanates used are aliphatic polyisocyanates, preferably hexamethylene diisocyanate and more preferably trimers of hexamethylene diisocyanate. It is also advantageous if aqueous blocked polyurethaneurea dispersion is exclusively anionically hydrophilized. This means that the polyurethaneurea dispersion is not cationically and/or nonionically hydrophilized, i.e. has no corresponding groups.

A blocking agent refers presently to compounds which are able to react with an isocyanate group and which can be eliminated from it again under defined conditions - thermally, for example. This procedure is referred to as deblocking. Having proved to be particularly advantageous in the context of the present invention is a low deblocking temperature. In a preferred embodiment, therefore, the deblocking temperature is less than 130° C.

Examples of suitable isocyanate-based crosslinkers which have proved to be suitable are those available under the tradename Imprafix 2794 from Covestro, Germany.

Polycarbodiimides react selectively with carboxylic acid groups in polymer chains. This type of crosslinking produces a conventional 3D polymer-crosslinked network. By comparison with polyisocyanates, polycarbodiimides are less sensitive to water and so achieve longer pot lives.

Melamine resins are very effective crosslinkers on account of their high reactivity. They require lower amounts added than isocyanates or carbodiimides. Melamine resins are often used in conjunction with hydroxyl-functional polymer resins, forming very hard networks, but are also able to react with acid groups. Melamine resins require very high crosslinking temperatures, which can be reduced by adding catalysts.

Polyaziridines are sometimes the most reactive crosslinkers and therefore highly efficient. Polyaziridines react selectively with carboxylic acid groups in polymer chains. This type of crosslinking generates conventional 3D polymer-crosslinked networks. Owing to the lower molecular weight, a substantially lower fraction is required by comparison with polyisocyanates and polycarbodiimides.

The peroxidic crosslinking produces a high degree of crosslinking in conjunction with favourable processing and broad applicability. The vulcanizing times, however, are very long.

For crosslinking with sulfur, it is usually necessary to add vulcanization accelerators in order to prevent the degradation phenomena at the temperatures employed for the crosslinking. The elasticity and low-temperature strength of the vulcanizates are usually lower.

### C) Pressure Sensitive Adhesive

For adhesive tapes to be able to be redetached without residue or destruction by stretching in the bond plane, they are required to possess particular adhesive properties. Hence on stretching there must be a marked drop in the tack of the adhesive tapes. The lower the bonding performance in the stretched state, the less significant the damage to the substrate on detachment or the less significant the risk that residues will remain on the bonding substrate. In this respect, pressure sensitive adhesives which have proved to be particularly advantageous are those based on vinylaromatic block copolymers, more particularly styrene block copolymers, as are used in the invention.

The vinylaromatic block copolymer is preferably at least one synthetic rubber in the form of a block copolymer having a A-B, A-B-A, (A-B)ₙ, (A-B)ₙX or (A-B-A)ₙX, structure, in which
A blocks independently of one another are a polymer formed by polymerization of vinylaromatics;
the B blocks independently of one another are a polymer formed by polymerization of conjugated dienes having 4 to 18 carbon atoms and/or isobutylene, or a partly or fully hydrogenated derivative of such a polymer;
X is the radical of a coupling reagent or initiator; and
n is an integer ≥ 2.

More particularly, all synthetic rubbers of the pressure sensitive adhesive according to the invention are block copolymers having a structure as detailed above. The pressure sensitive adhesive according to the invention may thus also comprise mixtures of various block copolymers having a structure as above.

Suitable block copolymers comprise one or more rubber-like blocks B (soft blocks) and one or more glass-like blocks A (hard blocks). More preferably, at least one synthetic rubber of the pressure sensitive adhesive according to the invention is a block copolymer having an A-B, A-B-A, (A-B)₃X or (A-B)₄X structure, where the above meanings are applicable to A, B and X, and where at least one block copolymer contains at least two hard blocks. Most preferably, all synthetic rubbers in the pressure sensitive adhesive according to the invention are block copolymers having an A-B, A-B-A, (A-B)₃X or (A-B)₄X structure, where the above meanings are applicable to A, B and X. More particularly, the synthetic rubber in the pressure sensitive adhesive according to the invention is a mixture of block copolymers having an A-B, A-B-A, (A-B)₃X or (A-B)₄X structure, preferably comprising at least diblock copolymers A-B and/or triblock copolymers A-B-A.

Also advantageous is a mixture of diblock and triblock copolymers and (A-B)ₙ or (A-B)ₙX block copolymers with n not less than 3.

The block copolymers that result from the A and B blocks may contain identical or different B blocks. The block copolymers may have linear A-B-A structures. It is likewise possible to use block copolymers in radial form and star-shaped and linear multiblock copolymers. Further components present may be A-B diblock copolymers. The aforementioned polymers may be used alone or in a mixture with one another, although A-B diblock copolymers are not usable alone.

The A block is in particular a glass-like block having a preferred glass transition temperature (Tg, DSC) above room temperature. More preferably the Tg of the glass-like block is at least 40° C., especially at least 60° C., very preferably at least 80° C. and most preferably at least 100° C. The proportion of vinylaromatic blocks A in the entirety of the block copolymers is preferably 10 to 40 wt%, more preferably 20 to 33 wt%. Vinylaromatics for forming the A block preferably comprise styrene and α-methylstyrene. The A block may thus be in the form of a homo- or copolymer. More preferably the A block is a polystyrene.

The B block is in particular a rubber-like block or soft block having a preferred Tg below room temperature. More preferably the Tg of the soft block is less than 0° C., especially less than -10° C., for example less than -40° C. and very preferably less than -60° C.

Monomer units for formation of the A block preferably include styrene, α-methylstyrene and/or other styrene derivatives. The A block may thus be in the form of a homo- or copolymer. More preferably, the A block is a polystyrene.

Preferred conjugated dienes as monomers for the soft block B are especially selected from the group consisting of butadiene, isoprene, ethylbutadiene, phenylbutadiene, piperylene, pentadiene, hexadiene, ethylhexadiene and dimethylbutadiene, and any desired mixtures of these monomers. The B block may also be in the form of a homopolymer or copolymer. More preferably, the conjugated dienes as monomers for the soft block B are selected from butadiene and isoprene. For example, the soft block B is a polyisoprene, a polybutadiene or a partly or fully hydrogenated derivative of one of these two polymers, such as polybutylene-butadiene in particular, or a polymer formed from a mixture of butadiene and isoprene. Most preferably, the B block is a polybutadiene.

A blocks in the context of this invention are also referred to as “hard blocks”. B blocks, correspondingly, are also called “soft blocks” or “elastomer blocks”. This reflects the inventive selection of the blocks in accordance with their glass transition temperatures - preferably for A blocks at least 25° C., more particularly at least 50° C., and for B blocks at most 25° C., more particularly at most -25° C.

In a preferred configuration, the total proportion of vinylaromatic block copolymers, based on the overall pressure sensitive adhesive, is 15 to 60 wt%, more preferably 20 to 50 wt%. Too low a proportion of vinylaromatic block copolymers has the result that the cohesion of the pressure sensitive adhesive is relatively low, and so the tear strength required for stripping is too low. Too high a proportion of vinylaromatic block copolymer in turn results in barely any pressure sensitive adhesion in the pressure sensitive adhesive.

Pressure sensitive adhesives according to the invention are based on vinylaromatic block copolymers, preferably admixed with tackifier resins that are miscible with the elastomer phase. The pressure sensitive adhesives include, as well as the at least one vinylaromatic block copolymer, preferably at least one tackifier resin in order to increase the adhesion in the desired manner. The tackifier resin should be compatible with the elastomer block of the block copolymers.

A “tackifier resin”, according to the general understanding of those skilled in the art, is understood to mean an oligomeric or polymeric resin that increases adhesion (tack, intrinsic tackiness) of the pressure sensitive adhesive compared to the pressure sensitive adhesive that does not contain any tackifier resin but is otherwise identical.

In a preferred embodiment, the adhesive layer consists of a pressure sensitive adhesive formed on the basis of vinylaromatic block copolymer and tackifier resins, with selection preferably to an extent of at least 30% by weight, and preferably to an extent of at least 50% by weight, based in each case on the total tackifier resin content, of a tackifier resin having a DACP (diacetone alcohol cloud point) of greater than -20° C., preferably greater than 0° C., and a softening temperature (Ring & Ball) of not less than 70° C., preferably not less than 100° C.

More preferably, the tackifier resins comprise at least 30 wt%, such as, in particular, at least 50 wt%, based in each case on the total tackifier resin content, of hydrocarbon resins or terpene resins or a mixture of the same.

It has been found that tackifier resins advantageously usable for the pressure sensitive adhesive(s) are especially nonpolar hydrocarbon resins, for example hydrogenated and non-hydrogenated polymers of dicyclopentadiene, non-hydrogenated, partly, selectively or fully hydrogenated hydrocarbon resins based on C₅, C₅/C₉ or C₉ monomer streams, and polyterpene resins based on α-pinene and/or β-pinene and/or δ-limonene. The aforementioned tackifier resins may be used either alone or in a mixture. It is possible to use either room temperature solid resins or liquid resins. Tackifier resins, in hydrogenated or non-hydrogenated form, which also contain oxygen, can optionally and preferably be used in the adhesive up to a maximum proportion of 70 wt%, based on the total mass of the resins.

The proportion of the resins that are liquid at room temperature, in a preferred variant, is up to 15 wt%, preferably up to 10 wt%, based on the overall pressure sensitive adhesive.

The pressure sensitive adhesive according to the invention preferably contains 20 to 60 wt%, based on the total weight of the pressure sensitive adhesive, of at least one tackifier resin. More preferably, tackifier resins are present to an extent of 30 to 50 wt%, based on the total weight of the pressure sensitive adhesive.

Further additives which may typically be utilized are:
plasticizers, for example plasticizer oils, or low molecular weight liquid polymers, for example low molecular weight polybutenes, preferably with a proportion of 0.2 to 5 wt%, based on the total weight of the pressure sensitive adhesive
primary antioxidants, for example sterically hindered phenols, preferably with a proportion of 0.2 to 1 wt%, based on the total weight of the pressure sensitive adhesive
secondary antioxidants, for example phosphites or thioethers, preferably with a proportion of 0.2 to 1 wt%, based on the total weight of the pressure sensitive adhesive
process stabilizers, for example C radical scavengers, preferably with a proportion of 0.2 to 1 wt%, based on the total weight of the pressure sensitive adhesive
light stabilizers, for example UV absorbers or sterically hindered amines, preferably with a proportion of 0.2 to 1 wt%, based on the total weight of the pressure sensitive adhesive
processing auxiliaries, preferably with a proportion of 0.2 to 1 wt%, based on the total weight of the pressure sensitive adhesive
endblock reinforcer resins, preferably with a proportion of 0.2 to 10 wt%, based on the total weight of the pressure sensitive adhesive, and
optionally further polymers that are preferably elastomeric in nature; correspondingly utilizable elastomers include, inter alia, those based on pure hydrocarbons, for example unsaturated polydienes such as natural or synthetically produced polyisoprene or polybutadiene, essentially chemically saturated elastomers, for example saturated ethylene-propylene copolymers, α-olefin copolymers, polyisobutylene, butyl rubber, ethylene-propylene rubber, and chemically functionalized hydrocarbons, for example halogenated, acrylated, allyl or vinyl ether-containing polyolefins, preferably with a proportion of 0.2 to 10 wt%, based on the total weight of the pressure sensitive adhesive.

The nature and amount of the blend components can be selected as required.

It is also in accordance with the invention when the adhesive does not include some of and preferably any of the respective admixtures mentioned.

In one embodiment of the present invention, the pressure sensitive adhesive also comprises further additives; non-limiting examples include crystalline or amorphous oxides, hydroxides, carbonates, nitrides, halides, carbides or mixed oxide/hydroxide/halide compounds of aluminium, of silicon, of zirconium, of titanium, of tin, of zinc, of iron or of the alkali metals/alkaline earth metals. These are essentially aluminas, for example aluminium oxides, boehmite, bayerite, gibbsite, diaspore and the like. Phyllosilicates are very particularly suitable, for example bentonite, montmorillonite, hydrotalcite, hectorite, kaolinite, boehmite, mica, vermiculite or mixtures thereof. But it is also possible to use carbon blacks or further polymorphs of carbon, for instance carbon nanotubes.

The adhesives may also be coloured with dyes or pigments. The adhesives may be white, black or coloured, as well as transparent.

Plasticizers incorporated by metered addition may, for example, be (meth)acrylate oligomers, phthalates, cyclohexanedicarboxylic esters, water-soluble plasticizers, plasticizing resins, phosphates or polyphosphates.

The addition of silicas, advantageously of precipitated silica surface-modified with dimethyldichlorosilane, can be utilized in order to adjust the thermal shear strength of the pressure sensitive adhesive.

In a preferred embodiment, the pressure sensitive adhesive of the invention has been foamed. The foaming is typically accomplished by the introduction and subsequent expansion of microballoons, as described above.

The absolute density of a foamed pressure sensitive adhesive according to the invention is preferably 220 to 990 kg/m³, more preferably 300 to 970 kg/m³, even more preferably 450 to 900 kg/m³, especially 500 to 850 kg/m³. The relative density describes the ratio of the density of the foamed pressure sensitive adhesive according to the invention to the density of the unfoamed pressure sensitive adhesive according to the invention having an identical formulation. The relative density of a pressure sensitive adhesive according to the invention is preferably 0.20 to 0.99, more preferably 0.30 to 0.97, especially 0.45 to 0.90, for example 0.50 to 0.85.

In a preferred embodiment of the invention, the adhesive consists solely of vinylaromatic block copolymer, optionally tackifier resins, microballoons and optionally the abovementioned additives.

Further preferably, the pressure sensitive adhesive consists of the following composition:
styrene block copolymer 20% to 75% by weight
tackifier resins 24.6% to 60% by weight
microballoons 0.2% to 10% by weight
additives 0.2% to 10% by weight

Further preferably, the adhesive consists of the following composition:
styrene block copolymer 35% to 65% by weight
tackifier resins 34.6% to 45% by weight
microballoons 0.2% to 10% by weight
additives 0.2% to 10% by weight

Pressure sensitive adhesives which have proven to be particularly suitable in this respect are styrene block copolymers, more particularly styrene-butadiene block copolymers. In one preferred embodiment, therefore, the styrene block copolymer forming the basis for the pressure sensitive adhesive comprises styrene-butadiene block copolymer.

The pressure sensitive adhesive layers of the adhesive tapes of the invention are based preferably on vinylaromatic block copolymers or on a blend of vinylaromatic block copolymer and polyacrylate, with the vinylaromatic block copolymer preferably being substantially immiscible with the polyacrylate. A blend of this kind consists preferably of 50 to 90 wt%, preferably 65 to 80 wt%, of polyacrylate and 10 to 50 wt%, preferably 20 to 35 wt%, of vinylaromatic block copolymer adhesive, with the two weight fractions adding up to 100 wt%.

A pressure sensitive adhesive (PSA) based on a polymer or a polymer mixture, i.e. on a polymer blend, is understood in the context of the present patent application to mean, in particular, that the polymer or polymer mixture represents at least 50 wt% of all the polymer components in the PSA, preferably at least 90 wt%. In one particularly preferred embodiment the polymer or polymer mixture constitutes the only polymer in the adhesive. Any tackifier resins present in the adhesive are considered in this context not to be polymers.

A “poly(meth)acrylate” is a polymer which is obtainable by radical polymerization of acrylic and/or methacrylic monomers and also, optionally, further, copolymerizable monomers. More particularly a “poly(meth)acrylate” is a polymer whose monomer basis consists to an extent of at least 50 wt% of acrylic acid, methacrylic acid, acrylic esters and/or methacrylic esters, with acrylic esters and/or methacrylic esters being included at least fractionally, preferably to an extent of at least 30 wt%, based on the overall monomer basis of the polymer in question.

The pressure sensitive adhesive of the invention comprises poly(meth)acrylate preferably at 35 to 65 wt% in total, more preferably at 40 to 60 wt% in total, based in each case on the total weight of the pressure-sensitive adhesive. One (single) poly(meth)acrylate or a plurality of poly(meth)acrylates may be present.

The glass transition temperature of the poly(meth)acrylate of the pressure-sensitive adhesive of the invention is preferably < 0° C., more preferably between -20 and -50° C.

The poly(meth)acrylate of the pressure-sensitive adhesive of the invention preferably comprises at least one fractionally copolymerized functional monomer, more preferably a monomer reactive with epoxide groups to form a covalent bond. Very preferably the fractionally copolymerized functional monomer, more preferably the monomer reactive with epoxide groups to form a covalent bond, contains at least one functional group selected from the group consisting of carboxylic acid groups, sulfonic acid groups, phosphonic acid groups, hydroxyl groups, acid anhydride groups, epoxide groups, and amino groups; more particularly it comprises at least one carboxylic acid group. Very preferably the poly(meth)acrylate of the pressure-sensitive adhesive of the invention comprises fractionally copolymerized acrylic acid and/or methacrylic acid. All of the stated groups have a reactivity with epoxide groups, so making the poly(meth)acrylate advantageously amenable to thermal crosslinking with introduced epoxides.

The poly(meth)acrylate of the pressure-sensitive adhesive of the invention may preferably be derived from the following monomer composition:
a) at least one acrylic ester and/or methacrylic ester of the following formula (1)

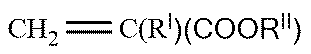

in which R^{I} = H or CH₃ and R^{II} is an alkyl radical having 4 to 18 carbon atoms;
b) at least one olefinically unsaturated monomer having at least one functional group selected from the group consisting of carboxylic acid groups, sulfonic acid groups, phosphonic acid groups, hydroxyl groups, acid anhydride groups, epoxide groups, and amino groups;
c) optionally further acrylic esters and/or methacrylic esters and/or olefinically unsaturated monomers which are copolymerizable with component (a).

It is particularly advantageous to select the monomers of component a) with a fraction of 45 to 99 wt%, the monomers of component b) with a fraction of 1 to 15 wt%, and the monomers of component c) with a fraction of 0 to 40 wt%, the figures being based on the monomer mixture for the base polymer without additions of possible additives such as resins, etc.

The monomers of component a) are generally plasticizing, relatively nonpolar monomers. More preferably R^{II} in the monomers a) is an alkyl radical having 4 to 10 carbon atoms or 2-propylheptyl acrylate or 2-propylheptyl methacrylate. The monomers of the formula (1) are selected more particularly from the group consisting of n-butyl acrylate, n-butyl methacrylate, n-pentyl acrylate, n-pentyl methacrylate, n-amyl acrylate, n-hexyl acrylate, n-hexyl methacrylate, n-heptyl acrylate, n-octyl acrylate, n-octyl methacrylate, n-nonyl acrylate, isobutyl acrylate, isooctyl acrylate, isooctyl methacrylate, 2-ethylhexyl acrylate, 2-ethylhexyl methacrylate, 2-propylheptyl acrylate and 2-propylheptyl methacrylate.

The monomers of component b) are more preferably selected from the group consisting of acrylic acid, methacrylic acid, itaconic acid, maleic acid, fumaric acid, crotonic acid, aconitic acid, dimethylacrylic acid, β-acryloyloxypropionic acid, trichloroacrylic acid, vinylacetic acid, vinylphosphonic acid, maleic anhydride, hydroxyethyl acrylate, especially 2-hydroxyethyl acrylate, hydroxypropyl acrylate, especially 3-hydroxypropyl acrylate, hydroxybutyl acrylate, especially 4-hydroxybutyl acrylate, hydroxyhexyl acrylate, especially 6-hydroxyhexyl acrylate, hydroxyethyl methacrylate, especially 2-hydroxyethyl methacrylate, hydroxypropyl methacrylate, especially 3-hydroxypropyl methacrylate, hydroxybutyl methacrylate, especially 4-hydroxybutyl methacrylate, hydroxyhexyl methacrylate, especially 6-hydroxyhexyl methacrylate, allyl alcohol, glycidyl acrylate, glycidyl methacrylate.

Illustrative monomers of component c) are:

methyl acrylate, ethyl acrylate, propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, tert-butylphenyl acrylate, tert-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenylyl acrylate, 4-biphenylyl methacrylate, 2-naphthyl acrylate, 2-naphthyl methacrylate, tetrahydrofurfuryl acrylate, diethylaminoethyl acrylate, diethylaminoethyl methacrylate, dimethylaminoethyl acrylate, dimethylaminoethyl methacrylate, methyl 3-methoxy acrylate, 3-methoxybutyl acrylate, 2-phenoxyethyl methacrylate, butyl diglycol methacrylate, ethylene glycol acrylate, ethylene glycol monomethyl acrylate, methoxypolyethylene glycol methacrylate 350, methoxypolyethylene glycol methacrylate 500, propylene glycol monomethacrylate, butoxydiethylene glycol methacrylate, ethoxytriethylene glycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, dimethylaminopropylacrylamide, dimethylaminopropylmethacrylamide, N-(1-methylundecyl)acrylamide, N-(n-butoxymethyl)acrylamide, N-(butoxymethyl)methacrylamide, N-(ethoxymethyl)acrylamide, N-(n-octadecyl)acrylamide; N,N-dialkyl-substituted amides such as, for example, N,N-dimethylacrylamide and N,N-dimethylmethacrylamide; N-benzylacrylamide, N-isopropylacrylamide, N-tert-butylacrylamide, N-tert-octylacrylamide, N-methylolacrylamide, N-methylolmethacrylamide, acrylonitrile, methacrylonitrile; vinyl ethers such as vinyl methyl ether, ethyl vinyl ether, vinyl isobutyl ether; vinyl esters such as vinyl acetate; vinyl halides, vinylidene halides, vinylpyridine, 4-vinylpyridine, N-vinylphthalimide, N-vinyllactam, N-vinylpyrrolidone, styrene, α- and p-methylstyrene, α-butylstyrene, 4-n-butylstyrene, 4-n-decylstyrene, 3,4-dimethoxystyrene; macromonomers such as 2-polystyreneethyl methacrylate (weight-average molecular weight Mw, determined by GPC, of 4000 to 13 000 g/mol), poly(methyl methacrylate)ethyl methacrylate (Mw of 2000 to 8000 g/mol).

Monomers of component c) may advantageously also be selected such that they contain functional groups which support subsequent radiation-chemical crosslinking (for example, by electron beams or UV radiation). Suitable copolymerizable photoinitiators are, for example, benzoin acrylate and acrylate-functionalized benzophenone derivatives. Monomers which support crosslinking by electron beam bombardment are, for example, tetrahydrofurfuryl acrylate, N-tert-butylacrylamide, and allyl acrylate.

The poly(meth)acrylates are prepared preferably by conventional radical polymerizations or controlled radical polymerizations. The poly(meth)acrylates may be prepared by copolymerizing the monomers using customary polymerization initiators and also, optionally, chain transfer agents, with polymerization taking place at the customary temperatures in bulk, in emulsion, for example in water or liquid hydrocarbons, or in solution.

The poly(meth)acrylates are preferably prepared by copolymerization of the monomers in solvents, more preferably in solvents having a boiling range of 50 to 150° C., more particularly of 60 to 120° C., using from 0.01 to 5 wt% of polymerization initiators, more particularly from 0.1 to 2 wt% of polymerization initiators, based in each case on the total weight of the monomers.

All customary initiators are suitable in principle. Examples of radical sources are peroxides, hydroperoxides and azo compounds, for example dibenzoyl peroxide, cumene hydroperoxide, cyclohexanone peroxide, di-tert-butyl peroxide, cyclohexylsulfonyl acetyl peroxide, diisopropyl percarbonate, tert-butyl peroctoate, and benzopinacol. Preferred radical initiators are 2,2'-azobis(2-methylbutyronitrile) (Vazo® 67™ from DuPont) or 2,2'-azobis(2-methylpropionitrile) (2,2'-azobisisobutyronitrile; AIBN; Vazo® 64™ from DuPont).

Preferred solvents for preparing the poly(meth)acrylates are alcohols such as methanol, ethanol, n- and isopropanol, n- and isobutanol, especially isopropanol and/or isobutanol; hydrocarbons such as toluene and, in particular, mineral spirits with a boiling range from 60 to 120° C.; ketones, especially acetone, methyl ethyl ketone, methyl isobutyl ketone; esters such as ethyl acetate; and mixtures of the aforementioned solvents. Particularly preferred solvents are mixtures containing isopropanol in amounts of 2 to 15 wt%, more particularly of 3 to 10 wt%, based in each case on the solvent mixture employed.

Preferably, after the preparation of the poly(meth)acrylates (polymerization), there is a concentration process, and the further processing of the poly(meth)acrylates is substantially solvent-free. The concentration of the polymer may take place in the absence of crosslinker and accelerator substances. It is also possible, however, for one of these classes of compound to be added to the polymer even before concentration, in which case the concentration takes place in the presence of said substance(s).

The polymers after the concentrating step may be transferred to a compounder. Concentration and compounding may optionally also take place in the same reactor.

The weight-average molecular weights Mw of the polyacrylates range preferably from 20 000 to 2 000 000 g/mol, very preferably 100 000 to 1 500 000 g/mol, most preferably 150 000 to 1 000 000 g/mol. To this end, it may be advantageous to carry out the polymerization in the presence of suitable chain transfer agents such as thiols, halogen compounds and/or alcohols, in order to establish the desired average molecular weight.

The figures for the number-average molecular weight Mn and the weight-average molecular weight Mw in this text are based on the determination by gel permeation chromatography (GPC) known per se. The determination is made on a 100 µl sample which has undergone clarifying filtration (sample concentration 4 g/l). The eluent used is tetrahydrofuran with 0.1 vol% of trifluoroacetic acid. The measurement is made at 25° C.

The pre-column used is a PSS-SDV column, 5 µm, 10³ Å, 8.0 mm * 50 mm (details here and below are in the following order: type, particle size, porosity, internal diameter * length; 1 Å = 10⁻¹⁰ m). Separation takes place using a combination of the PSS-SDV columns, 5 µm, 10³ Å and also 10⁵ Å and 10⁶ Å, each with 8.0 mm * 300 mm (columns from Polymer Standards Service; detection using Shodex RI71 differential refractometer). The flow rate is 1.0 ml per minute. Calibration takes place against PMMA standards (polymethyl methacrylate calibration) in the case of poly(meth)acrylates, and otherwise (resins, elastomers) against PS standards (polystyrene calibration).

The poly(meth)acrylates preferably have a K value of 30 to 90, more preferably of 40 to 70, measured in toluene (1% strength solution, 21° C.). The K value according to Fikentscher is a measure of the molecular weight and the viscosity of polymers.

The principle of the method is based on the determination of the relative solution viscosity by capillary viscometry. For this purpose the substance under test is dissolved in toluene by shaking for 30 minutes, to give a 1% strength solution. The flow time from a Vogel-Ossag viscometer is measured at 25° C. and from this the relative viscosity of the sample solution is determined, in relation to the viscosity of the pure solvent. The K value can be read off from tables by the method of Fikentscher [P. E. Hinkamp, Polymer, 1967, 8, 381] (K = 1000 k).

The poly(meth)acrylate of the PSA of the invention preferably has a polydispersity PD < 4 and hence a relatively narrow molecular weight distribution. Compositions based thereon, despite a relatively low molecular weight, have especially good shear strength after the crosslinking step. Moreover, the lower polydispersity enables easier processing from the melt, since the flow viscosity is lower than that of a more broadly distributed poly(meth)acrylate with largely the same performance properties. Narrowly distributed poly(meth)acrylates may be prepared advantageously by anionic polymerization or by controlled radical polymerization techniques, the latter being especially suitable. Such poly(meth)acrylates may also be prepared via N-oxyls. Additionally, in an advantageous way, it is possible to employ atom transfer radical polymerization (ATRP) in order to synthesize narrowly distributed poly(meth)acrylates, in which case the initiator used preferably comprises monofunctional or difunctional, secondary or tertiary halides, with abstraction of the halides being carried out using complexes of Cu, Ni, Fe, Pd, Pt, Ru, Os, Rh, Co, Ir, Ag or Au. RAFT polymerization is also suitable.

The poly(meth)acrylates of the PSA of the invention are crosslinked preferably by linking reactions — especially in the sense of addition or substitution reactions — of functional groups they contain with thermal crosslinkers. It is possible to use all thermal crosslinkers which
both ensure a sufficiently long working time, so that there is no gelling during the processing operation, especially the extrusion procedure,
and lead to rapid postcrosslinking of the polymer to the desired degree of crosslinking at temperatures lower than the processing temperature, more particularly at room temperature.

Possible, for example, is a combination of polymers containing carboxyl, amino and/or hydroxyl groups, and as crosslinker isocyanates, especially aliphatic or blocked isocyanates, examples being trimerized isocyanates deactivated with amines. Suitable isocyanates are, in particular, trimerized derivatives of MDI [4,4-methylenedi(phenyl isocyanate)], HDI [hexamethylene diisocyanate, 1,6-hexylene diisocyanate], and IPDI [isophorone diisocyanate, 5-isocyanato-1-isocyanatomethyl-1,3,3-trimethylcyclohexane].

Preference is given to using thermal crosslinkers at 0.1 to 5 wt%, more particularly at 0.2 to 1 wt%, based on the total amount of the polymer to be crosslinked.

Also possible is crosslinking via complexing agents, also referred to as chelates. An example of a preferred complexing agent is aluminium acetylacetonate.

The poly(meth)acrylates of the PSA of the invention are crosslinked preferably by means of one or more epoxides or substances containing epoxide groups. The substances containing epoxide groups are, in particular, polyfunctional epoxides, these being those having at least two epoxide groups; accordingly there is overall an indirect linking of the constituents in the poly(meth)acrylates that carry the functional groups. The substances containing epoxide groups may be aromatic compounds and aliphatic compounds.

Outstandingly suitable polyfunctional epoxides are oligomers of epichlorohydrin, epoxy ethers of polyhydric alcohols, especially ethylene, propylene and butylene glycols, polyglycols, thiodiglycols, glycerol, pentaerythritol, sorbitol, polyvinyl alcohol, polyallyl alcohol and the like; epoxy ethers of polyhydric phenols, more particularly resorcinol, hydroquinone, bis(4-hydroxyphenyl)methane, bis(4-hydroxy-3-methylphenyl)methane, bis(4-hydroxy-3,5-dibromophenyl)methane, bis(4-hydroxy-3,5-difluorophenyl)methane, 1,1-bis(4-hydroxyphenyl)ethane, 2,2-bis(4-hydroxyphenyl)propane, 2,2-bis(4-hydroxy-3-methylphenyl)propane, 2,2-bis(4-hydroxy-3-chlorophenyl)propane, 2,2-bis(4-hydroxy-3,5-dichlorophenyl)propane, 2,2-bis(4-hydroxy-3,5-dichlorophenyl)propane, bis(4-hydroxyphenyl)phenylmethane, bis(4-hydroxyphenyl)phenylmethane, bis(4-hydroxyphenyl)diphenylmethane, bis(4-hydroxyphenyl)-4'-methylphenylmethane, 1,1-bis(4-hydroxyphenyl)-2,2,2-trichloroethane, bis(4-hydroxyphenyl)-(4-chlorophenyl)methane, 1,1-bis(4-hydroxyphenyl)cyclohexane, bis(4-hydroxyphenyl)cyclohexylmethane, 4,4'-dihydroxybiphenyl, 2,2'-dihydroxybiphenyl, 4,4'-dihydroxydiphenyl sulfone and also the hydroxyethyl ethers thereof; phenol-formaldehyde condensation products such as phenol alcohols and phenol-aldehyde resins; S- and N-containing epoxides, for example N,N-diglycidylaniline and N,N′-dimethyldiglycidyl-4,4-diaminodiphenylmethane; and also epoxides prepared by customary processes from polyunsaturated carboxylic acids or monounsaturated carboxylic esters of unsaturated alcohols; glycidyl esters; polyglycidyl esters obtainable by polymerization or copolymerization of glycidyl esters of unsaturated acids or obtainable from other acidic compounds, for example from cyanuric acid, diglycidyl sulfide or cyclic trimethylenetrisulfone and/or derivates thereof.

Examples of very suitable ethers are 1,4-butanediol diglycidyl ether, polyglycerol-3-glycidyl ether, cyclohexanedimethanol diglycidyl ether, glycerol triglycidyl ether, neopentyl glycol diglycidyl ether, pentaerythritol tetraglycidyl ether, 1,6-hexanediol diglycidyl ether, polypropylene glycol diglycidyl ether, trimethylolpropane triglycidyl ether, pentaerythritol tetraglycidyl ether, bisphenol A diglycidyl ether and bisphenol F diglycidyl ether.

Further preferred epoxides are cycloaliphatic epoxides such as 3,4-epoxycyclohexylmethyl 3,4-epoxycyclohexanecarboxylate (UVACure1500).

The poly(meth)acrylates are crosslinked more preferably using a crosslinker-accelerator system (“crosslinking system”) in order to obtain more effective control over the processing time, the crosslinking kinetics and the degree of crosslinking. The crosslinker accelerator system preferably comprises at least one epoxide-group-containing substance as crosslinker and at least one substance as accelerator which has an accelerating effect for crosslinking reactions by means of compounds containing epoxide groups at a temperature below the melting temperature of the polymer to be crosslinked.

Accelerators used very preferably in the invention are amines. These are to be interpreted formally as substitution products of ammonia; in the formulae which follow, the substituents are represented by “R” and encompass, in particular, alkyl and/or aryl radicals. Particular preference is given to using amines which undergo no reactions or only minor reactions with the polymers that are to be crosslinked.

Accelerators which can be selected include in principle primary (NRH2), secondary (NR2H) and tertiary (NR3) amines, including of course those which have two or more primary and/or secondary and/or tertiary amino groups. Particularly preferred accelerators are tertiary amines such as, for example, triethylamine, triethylenediamine, benzyldimethylamine, dimethylaminomethylphenol, 2,4,6-tris(N,N-dimethylaminomethyl)phenol, N,N'-bis(3-(dimethylamino)propyl)urea. Further preferred accelerators are polyfunctional amines such as diamines, triamines and/or tetramines, for example diethylenetriamine, triethylenetetramine, trimethylhexamethylenediamine.

Other preferred accelerators are amino alcohols, especially secondary and/or tertiary amino alcohols, and if there are two or more amino functionalities per molecule then preferably at least one and more preferably all of the amino functionalities are secondary and/or tertiary. Particularly preferred such accelerators are triethanolamine, N,N-bis(2-hydroxypropyl)ethanolamine, N-methyldiethanolamine, N-ethyldiethanolamine, 2-amino-cyclohexanol, bis(2-hydroxycyclohexyl)methylamine, 2-(diisopropylamino)ethanol, 2-(di-butylamino)ethanol, N-butyldiethanolamine, N-butylethanolamine, 2-[bis(2-hydroxy-ethyl)amino]-2-(hydroxymethyl)-1,3-propanediol, 1-[bis(2-hydroxyethyl)amino]-2-propanol, triisopropanolamine, 2-(dimethylamino)ethanol, 2-(diethylamino)ethanol, 2-(2-dimethylaminoethoxy)ethanol, N,N,N′-trimethyl-N′-hydroxyethylbisaminoethyl ether, N,N,N′-trimethylaminoethylethanolamine and N,N,N′-trimethylaminopropylethanolamine.

Further suitable accelerators are pyridine, imidazoles, such as 2-methylimidazole, and 1,8-diazabicyclo[5.4.0]undec-7-ene. Cycloaliphatic polyamines can also be used as accelerators. Also suitable are phosphorus-based accelerators such as
phosphines and/or phosphonium compounds, for example triphenylphosphine or tetraphenylphosphonium tetraphenyl borate.
Quaternary ammonium compounds as well can be used as accelerators; examples are tetrabutylammonium hydroxide, cetyltrimethylammonium bromide and benzalkonium chloride.

As is generally always the case in such PSAs, poly(meth)acrylate and synthetic rubber are each present respectively as homogeneous phases in the PSA of the invention, preferably. More preferably the synthetic rubber is in dispersion in the poly(meth)acrylate.

Preferably, therefore, the poly(meth)acrylates and synthetic rubbers present in the PSA are not miscible with one another to homogeneity at 23° C. The PSA of the invention therefore preferably has an at least two-phase morphology at least microscopically and at least at room temperature. More preferably poly(meth)acrylate(s) and synthetic rubber(s) are not homogeneously miscible with one another in a temperature range from -20° C. to 90° C., more particularly from 0° C. to 60° C., and so in these temperature ranges at least microscopically the PSA is present as at least two phases.

Components are defined as “not homogeneously miscible with one another” in the sense of this specification when even after intimate mixing, the formation of at least two stable phases, physically and/or chemically, is detectable at least microscopically, with one phase being rich in one component and the second phase being rich in the other component. The presence of negligibly small amounts of one component in the other component does not go against the formation of the multi-phase system, and is considered to be inconsequential. Hence there may be small amounts of synthetic rubber in the poly(meth)acrylate phase and/or small amounts of poly(meth)acrylate component in the synthetic rubber phase, these not being significant amounts which influence the phase separation.

The phase separation may be realized in particular such that discrete regions (“domains”) which are rich in synthetic rubber— in other words are essentially formed of synthetic rubber — are present in a continuous matrix which is rich in poly(meth)acrylate — in other words is essentially formed of poly(meth)acrylate. One suitable system of analysis for a phase separation is scanning electron microscopy, for example. Alternatively phase separation may also be detectable, for example, by the different phases having two glass transition temperatures independent of one another in dynamic scanning calorimetry (DSC) or dynamic mechanical analysis (DMA). Phase separation is present in accordance with the invention especially when it can be clearly shown by at least one of the analytical methods.

Additional multi-phase character may also be present as a fine structure within the synthetic rubber-rich domains, with the A blocks forming one phase and the B blocks forming a second phase.

In one embodiment of the invention, one or both surfaces of the PSA layers are physically and/or chemically pretreated. Such pretreatment may take place by plasma pretreatment, for example. Where both surfaces of the PSA layers are pretreated, the pretreatment of each surface may be different or, in particular, both surfaces may have the same pretreatment.

Plasma treatment — more particularly low-pressure plasma treatment — is a known method for pretreating surfaces of adhesives. The plasma leads to activation of the surface in the sense of a higher reactivity. In this case there are chemical changes to the surface, allowing the behaviour of the adhesive with respect to polar and apolar surfaces to be influenced, for example. This pretreatment involves substantially surface phenomena.

The PSA layers of the invention are typically 10 to 200 µm thick, preferably 15 to 100 µm thick and more particularly 25 to 60 µm thick.

### D) Adhesive Tape

For adhesive tapes to be able to be redetached easily and without residue by extensive stretching, they must possess not only the adhesive properties described above but also certain mechanical properties. With particular advantage the ratio of the tearing force to the stripping force is greater than two, preferably greater than three. This stripping force is the force which has to be expended in order to redetach an adhesive tape from a bonded joint by extensive stretching in the bond plane. This stripping force is made up of the force which is needed, as described above, to detach the adhesive tape from the bonding substrates, and the force that has to be expended for deformation of the adhesive tape. The force required for deforming the adhesive tape is dependent on the thickness of the adhesive tape. The force required for detachment, in contrast, is independent of the thickness of the adhesive tape, within the adhesive tape thickness range under consideration.

Preference is therefore given to an embodiment in which the adhesive tape has a ratio of stripping force Fₛₜᵣᵢₚ to breaking force F_{break} of less than 60%, preferably less than 50%.

The carrier is preferably coated on at least one side with the pressure sensitive adhesive, but more preferably on both sides. The adhesive tape may therefore be a single-sided adhesive tape or a double-sided adhesive tape, and preferably is double-sided.

The thickness of the adhesive tape can be chosen according to use. In one preferred embodiment the adhesive tape has a thickness of 30 to 350 µm, preferably 30 to 250 µm and more preferably 50 to 200 µm.

### E) Production Methods

A further subject of the present invention is a method for producing the adhesive tape of the invention.

### I) TPU-Based Carrier

In a first alternative the method of the invention relates to a method for producing an adhesive tape according to the present invention, wherein a crosslinked polyurethane
(i) is extruded onto a temporary carrier and combined on at least one side, preferably both sides, with a pressure sensitive adhesive layer based on vinylaromatic block copolymer, or
(ii) is extruded onto a pressure sensitive adhesive layer based on vinylaromatic block copolymer to give a carrier, the carrier preferably being combined, on the side opposite the pressure sensitive adhesive layer, with a further pressure sensitive adhesive layer based on vinylaromatic block copolymer,
to give an adhesive tape.

All of the constituents of the formula to be produced, based on TPU, are first dried in a granule drier and then supplied to a continuous mixing or conveying assembly with mixing section via metering openings and metering or conveying systems. The temperature regime is in line with the optimal conditions required for producing a homogeneous mixture.

The outlet of the continuous conveying assembly with mixing section or mixing assembly, and/or the further components for conveying the extrudate to preliminary forming via a die or distributor channel or directly to the coating unit, may have different configurations. For coating a flat film, a slot die is suitable for the preliminary forming of the extrudate or of a melt film. This extrudate or film may be deposited either directly onto a rotating roll which in general is cooled (called a chill roll), in which case the layer thickness may additionally be regulated via the take-off speed. Or coating may take place directly onto a preliminary material, for example a (temporary) carrier or functional layer, such as more particularly a pressure sensitive adhesive layer.

In one particularly advantageous embodiment of the method of the invention, the extrudate, homogenized beforehand, is shaped via a slot die to form a melt film and is coated directly onto a first layer of adhesive, which is arranged on a temporary carrier, such as a (siliconized) liner in particular. This prefabricated functional layer is supplied beforehand preferably using an unwind station via the chill roll.

This assembly composed of temporary carrier (liner), adhesive layer and PU layer, before being wound into a bale, is preferably laminated to a second prefabricated adhesive layer on a temporary carrier, such as a release liner in particular. The end product now consists of three layers, adhesive — PU carrier — adhesive, sandwiched between two temporary carriers, such as liners in particular. One temporary carrier (such as a liner in particular) may be removed before winding to a bale.

This procedure has numerous advantages: a multi-ply product is particularly efficient to produce; the composite strength/anchoring between adhesive or carrier layer of each kind and TPU layer is improved; the often problematic intermediate step of transfer coating (TPU to release carrier) is avoided. Accordingly, even particularly soft TPU products become amenable to production, and there is no need for process assistants, such as waxes and/or lubricants, coextruded supporting carriers or additional auxiliary liners of the kind typically required when producing TPU carriers.

Within the method of the invention it is also possible to use foamed carriers based on TPU.

All of the constituents of the formula to be produced, based on TPU (after drying), including the unexpanded microballoons, are for this purpose supplied preferably to a continuous mixing or conveying assembly with a mixing section, via a metering aperture and metering or conveying systems. The temperature regime is in line with the optimal conditions required for production of a homogeneous mixture and the foaming of the microballoons. Up to the outlet, there is preferably a continuous opposing pressure maintained in order to prevent premature expansion of the microballoons.

The outlet of a continuous conveying assembly with mixing section or mixing assembly and/or the further components for conveying the extrudate for preliminary forming via a die or distributor channel, or directly to the coating unit, may have different configurations. For coating of a flat film, a slot die is suitable for preliminary forming of the extrudate or of a melt film. The expanded or expanding microballoons are preferably prevented from breaking through the coated surface by an opposing pressure which is built up during the coating procedure. In this way a rough surface can be prevented, such a surface in turn giving rise to poor anchoring to the pressure sensitive adhesive layer. The opposing pressure may be, for example, an impression roll or opposing roll on the coating roll, or coating is carried out directly in a calender. Here as well, coating takes place preferably directly onto a preliminary material, for example a (temporary) carrier or a pressure sensitive adhesive layer applied to a temporary carrier.

This assembly of temporary carrier (liner), adhesive layer and PU layer, before being wound to form a bale, is preferably laminated to a second prefabricated adhesive layer on a temporary carrier, such as a release liner in particular or any other kind of carrier layer, on the opposite side.

The end product consists preferably of three layers, adhesive — foamed PU carrier — adhesive, sandwiched between two temporary carriers, such as liners. One temporary carrier (liner) may be removed before winding to a bale takes place. Direct coating onto a PSA layer has numerous advantages: a multi-ply product is particularly efficient to produce; the composite strength/anchoring between adhesive and carrier layer of any kind or TPU layer is improved; the often problematic intermediate step of transfer coating (TPU to release carrier) is avoided. In this way, even particularly soft TPU products become amenable to production and there is no need for process assistants, such as waxes and/or lubricants, coextruded supporting carriers or additional auxiliary liners are as typically required in the production of TPU carriers.

Closed-cell TPU foams containing microballoons are not available commercially, and so this method of the invention and the resultant carrier layers form the basis for innovative products.

Further options for producing open-cell TPU foams are available: the addition of chemical blowing agents or the controlled injection of gas, i.e., a physical blowing agent.

The chemical blowing agent may be added directly with the starting materials to the continuous conveying assembly with mixing section, or via one of the additional metering apertures. Processing and coating take place preferably as described above.

Gas may be injected via an additional metering aperture into the extruder, into the melt mixture. The gas is preferably supplied in a regulated way, allowing the gas fraction in the mixture and the resulting density to be adjusted. Processing and coating take place preferably as described above.

### ii) PUD-Based Carrier

An alternative embodiment relates to a method for producing the adhesive tape of the invention, wherein a dispersion based on a polyurethane and a crosslinker
(i) is coated onto a temporary carrier or dried, and the resultant carrier is combined on at least one side, preferably both sides, with a pressure sensitive adhesive layer based on vinylaromatic block copolymer, or
(ii) is coated onto a pressure sensitive adhesive layer based on vinylaromatic blockcopolymer to give a carrier and dried, the carrier preferably being combined, on the side opposite the pressure sensitive adhesive layer, with a further pressure sensitive adhesive layer based on vinylaromatic block copolymer,
to give an adhesive tape.

For producing a homogeneous, bubble-free dispersion mixture, stirring equipment suitable for dispersions is advised. Crosslinkers, thickeners and/or other additives are usually predispersed with water and then supplied to the PU dispersion in portions with continuous, cautious stirring.

During the stirring operation, vortices or excessive speeds should be avoided, in order to prevent unwanted incorporation of air by stirring. It is advisable to make up the blend a number of hours prior to coating, in order to promote the escape of small air bubbles that have been introduced by stirring.

Coating may take place via different applicator systems, for example doctor blade, die or distributor channels, etc. The coated PU dispersion is dried preferably via supply of heat in a drying tunnel with different heating zones. The PU dispersion may be coated either onto a (temporary) carrier or directly onto a PSA layer. After the drying and before the winding, preferably a second PSA layer is laminated onto the opposite side, allowing a multi-ply product to be produced in one step. The multilayer assembly thus produced is preferably wound up to form a bale. A liner or other auxiliary carrier may be removed beforehand.

This procedure has numerous advantages: a multi-ply product is particularly efficient to produce; the composite strength/anchoring between adhesive, carrier layer of any kind or PU layer is improved; the often problematic intermediate step of transfer coating (PU to release carrier) is avoided.

The PU-based carrier layer from dispersion, or the adhesive tape comprising this layer, may be subjected to a heat treatment at not less than 150° C. in order to optimize tensile strength.

In one preferred embodiment, production takes place using a carrier based on a foamable PU dispersion.

To produce a homogeneous, bubble-free dispersion mixture foamable with microballoons, stirring equipment suitable for dispersions is recommended. Crosslinkers, thickeners and/or other additives, and the unexpanded microballoons, are preferably predispersed with water and then supplied to the PU dispersion in portions with continual, cautious stirring. During the stirring operation, vortices or excessive speeds ought to be avoided, in order to prevent unwanted introduction of air by stirring. It is advisable to prepare the blend a number of hours prior to coating, in order to promote the escape of small air bubbles which have been introduced by stirring.

Coating may take place via different applicator systems, for example doctor blade, die or distributor channels, etc. The coated PU dispersion is dried preferably via supply of heat below the foaming temperature in a drying tunnel with different heating zones. The PU dispersion may be coated either onto a (temporary) carrier or directly onto a PSA layer. After the drying and before the winding, preferably a second PSA layer is laminated onto the opposite side, allowing a multi-ply product to be produced in one step.

The multilayer assembly thus produced is preferably wound into a bale. A liner or other auxiliary carrier may be removed beforehand. This procedure has numerous advantages: a multi-ply product is particularly efficient to produce; the composite strength/anchoring between adhesive or carrier layer of any kind or PU layer is improved; the often problematic intermediate step of transfer coating (PU to release carrier) is avoided.

In a further operating step, the overall assembly or an individual layer of the foamable PU carrier is partly or fully foamed, and/or the microballoons are expanded, by further supply of heat through a heating tunnel or heatable contact rolls. The sandwiching of the foamable PU carrier with carrier, auxiliary liner or PSA layer prevents the expanding microballoons breaking through the surface, and so good bond strength is achieved between the individual layers. As a result of the foaming with microballoons, a closed-cell PU foam is generated.

In a further embodiment, the PU dispersion may be admixed with pre-expanded microballoons, likewise generating a foamed PU carrier. By lamination of at least one PSA layer it is likewise possible to produce a single- or double-sided adhesive tape.

By targeted introduction of air by stirring, referred to as frothing, it is additionally possible to produce an open-cell PU foam. Here, by means of stirring equipment suitable for the purpose and particular stirring conditions, the beating-in of air is induced in a controlled way. The further production operation takes place preferably analogously to the method described above.

A particular feature of the adhesive tape of the invention is that it can be redetached without residue or destruction with relatively low force expenditure, so making it especially suitable for the production of electronic components. A further subject of the present invention, therefore, is the use of the adhesive tape of the invention for bonding components in electronic devices.

A further subject of the present invention is an electronic device comprising a first component and a second component, bonded with an adhesive tape of the invention.

The invention is elucidated in more detail below by a number of illustrative adhesive tapes. By means of the examples described hereinafter, particularly advantageous implementations of the invention are elucidated in more detail, without any intention therewith to restrict the invention unnecessarily.

### Examples

Table 1 shows the (raw) materials used in the (comparative) examples. Tables 2 and 3 show the formulas of the carriers and adhesive layers produced in the (comparative) examples.

TABLE 1

(Raw) materials used in the (comparative) examples

| | | |
|---|---|---|
| Raw material | Manufacturer/supplier | Description |
| Impranil DL 1116 (for producing the carriers here called “PUD1” and “PUD2” and “PUD3” and “PUD4” and “PUD5” and “PUD6” respectively) | Covestro | Anionically stabilized polyester PU dispersion, 100% modulus (film of dispersion thickened with 1 wt% Borchigel ALA) = 1.4 MPa to DIN 53504 |
| Ortegol PV 301 | Evonik | Polyurethane solution (thickener) |
| Imprafix 2794 | Covestro | Blocked aliphatic polyisocyanate, water-based, NCO content (blocked, calculated for resin solids) 11.5 ± 0.5 |
| Levanox white R-LF | Lanxess, Rheinchemie Additives | Aqueous, solvent-free, inorganic pigment preparation; pigment content around 70% |
| Expancel 920 DU 20 | Nouryon | Unexpanded, expandable, dry microballoons with a mean diameter after expansion of 20 µm |
| Platilon U04 (called carrier “TPU1” here): film from blown film extrusion production plant | epurex | Blown film (TPU film) in thicknesses of 30 µm, 50 µm and 100 µm, each furnished on one side with PE supporting carrier, Shore A hardness = 86 |
| Kraton D 1116 AT | Kraton Performance Polymers, Inc. | Styrene-butadiene-styrene block copolymer |
| Kraton D 1118 ES | Kraton Performance Polymers, Inc. | Elastomer: styrene-butadiene-styrene triblock copolymer with 78 wt% diblock, block polystyrene content: 33 wt% |
| Kraton D 1152 ES | Kraton Performance Polymers, Inc. | Styrene-butadiene-styrene triblock copolymer |
| Irganox 1010 | BASF SE | Ageing inhibitor |
| Wingtack 10 | Cray Valley USA, LLC | Liquid hydrocarbon resin (plasticizing resin) |
| Dercolyte A115 | DRT | Solid α-pinene tackifier resin, Ring and Ball softening temperature: 115° C. |
| Acrylic acid | BASF SE | Acrylic acid |
| Butyl acrylate | CIM Chemicals AG | Butyl acrylate |
| Methyl acrylate | BASF SE | Methyl acrylate |
| Ethylhexyl acrylate | CIM Chemicals AG | Ethylhexyl acrylate |
| Phenoxyethyl acrylate | BASF SE | Phenoxyethyl acrylate |
| Erisys GA-240 | CVC Thermoset Specialites | N,N,N′,N′-Tetrakis(2,3-epoxypropyl)-m-xylene-a,a′-diamine |
| Aluminium acetylacetonate | Merck KGaA | Aluminium acetylacetonate |

TABLE 2

Formulas of the carriers produced in the (comparative) examples

| | | | |
|---|---|---|---|
| Carrier designation | Component | Raw material | Proportion |
| Core layer TPU 1 | Platilon U04 | epurex, film was bought in | |
| Core layer PUD 1 | PU dispersion | Impranil DL 1116 | 99.0 wt% |
| | Thickener | Ortegol PV 301 | 0.6 wt% |
| Core layer PUD 2 | PU dispersion | Impranil DL 1116 | 97.0 wt% |
| | Dye | Lanxess white R-LF | 2.0 wt% |
| | Thickener | Ortegol PV 301 | 0.6 wt% |
| Core layer PUD 3 | PU dispersion | Impranil DL 1116 | 98.4 wt% |
| | Dye | Lanxess white R-LF | 2.0 wt% |
| | Crosslinker | Imprafix 2794 | 1.0 wt% |
| | Thickener | Ortegol PV 301 | 0.6 wt% |
| Core layer PUD 4 | PU dispersion | Impranil DL 1116 | 97.4 wt% |
| | Dye | Lanxess white R-LF | 2.0 wt% |
| | Crosslinker | Imprafix 2794 | 2.0 wt% |
| | Thickener | Ortegol PV 301 | 0.6 wt% |
| Core layer PUD 5 | PU dispersion | Impranil DL 1116 | 94.4 wt% |
| | Dye | Lanxess white R-LF | 2.0 wt% |
| | Crosslinker | Imprafix 2794 | 6.0 wt% |
| | Thickener | Ortegol PV 301 | 0.6 wt% |
| Core layer PUD 6 | PU dispersion | Impranil DL 1116 | 97.4 wt% |
| | Crosslinker | Imprafix 2794 | 2.0 wt% |
| | Thickener | Ortegol PV 301 | 0.6 wt% |

TABLE 3

Formulas of the adhesive layers produced in the (comparative) examples

| | | | |
|---|---|---|---|
| Adhesive designation | Component | Raw material | Proportion |
| PSA layer A | Synthetic rubber | Kraton 1152 | 48.6 wt% |
| | Resin part | Dercolyte A115 | 45.7 wt% |
| | | Wingtack 10 | 3.0 wt% |
| | Ageing inhibitor | Irganox 1010 | 1.2 wt% |
| | Microballoons | Expancel 920 DU20 | 1.5 wt% |
| PSA layer B (comp.) | Polyacrylate | Acrylic acid | 3.0 wt% |
| | | Ethylhexyl acrylate | 50.0 wt% |
| | | Butyl acrylate | 47.0 wt% |
| | Crosslinker | Erisys GA 240 | 0.025 wt% |
| | | Aluminium acetylacetonate | 0.05 wt% |
| | Microballoons | Expancel 920DU20 | 0.75 wt% |
| PSA layer C | Synthetic rubber | Kraton 1118 | 66.7 wt% |
| | | Kraton 1116 | 32.3 wt% |
| | Resin part | Dercolyte A115 | 20.2 wt% |
| | Polyacrylate | Acrylic acid | 3.0 wt% |
| | | Methyl acrylate | 20.0 wt% |
| Polyacrylate/ synthetic rubber (wt% total; weight ratio) 79; 3:1 | | Butyl acrylate | 47.0 wt% |
| | | Phenoxyethyl acrylate | 30.0 wt% |
| | Crosslinker | Erisys GA 240 | 0.035 wt% |
| | | Aluminium acetylacetonate | 0.05 wt% |
| | Microballoons | Expancel 920 DU20 | 0.75 wt% |

Table 4 shows the structure of the adhesive tapes of the (comparative) examples, formed by combining the abovementioned carriers from Table 2 and pressure sensitive adhesives (PSAs) from Table 3. The adhesive tapes are each double-sided, meaning that one PSA layer is arranged on each side of the carrier.

TABLE 4

Structure of the adhesive tapes of the (comparative) examples

| Example | Carrier | | PSA layer | | Adhesive tape |
|---|---|---|---|---|---|
| | Variant | Thickness | Designation | Thickness | Thickness |
| | | | (on each side) | | |
| | | [µm] | | [µm] | [µm] |
| 1 (comp.) | TPU 1 | 50 | A | 50 | 150 |
| 2 (comp.) | PUD 1 | 50 | A | 50 | 150 |
| 3 (comp.) | PUD 2 | 50 | A | 50 | 150 |
| 4 | PUD 3 | 50 | A | 50 | 150 |
| 5 | PUD 4 | 50 | A | 50 | 150 |
| 6 | PUD 5 | 50 | A | 50 | 150 |
| 7 | PUD 6 | 50 | A | 50 | 150 |
| 8 (comp.) | PUD 6 | 50 | B | 50 | 150 |
| 9 | PUD 4 | 50 | C | 50 | 150 |

The individual adhesive tapes were produced as follows:

### Production of Adhesive Tapes With TPU Core Layer TPU 1 (Example 1)

The bought-in, process assistant-containing TPU core layers TPU 1 are laminated on both sides with the PSA layer A. Prior to the lamination of the TPU core layers TPU 1 with the PSA layers, the supporting PE carrier is removed in each case from the TPU core layer. The PSA layers have the same thickness on both sides of the carrier. The microballoons in the PSA layer A are still unexpanded, i.e. the PSA layer A is not yet foamed.

The overall assembly of carrier and PSA layers is subjected to a further heat treatment step in each case for better anchoring and foaming of the PSA layers. For this treatment the wound material is run through a tunnel system with a temperature profile comprising three zones of 120° C./135° C./170° C. and at a belt speed of 6 m/min, after which it is wound up again. The result is a foamed, double-sided adhesive tape having a TPU core layer TPU 1.

### Production of Adhesive Tapes With PUD Core Layers PUD 1 to PUD 6 (Examples 2 to 9)

If a thickener is used, the polyurethane dispersion (PU dispersion, PUD) is blended with the thickener by way of a conventional vertical stirrer apparatus having a Visco Jet stirrer. The polyurethane dispersion in this case is introduced in a container of sufficient size, and cautiously stirred. The formation of vortices or any introduction of air by stirring shall be avoided throughout the blending operation. All further constituents, such as the crosslinker solution, the dye solution and the thickener solution, were supplied in portions, with continual stirring, to the polyurethane dispersion initially introduced. To obtain a homogeneous mixture, a stirring time of at least 30 minutes is observed. The thickened polyurethane dispersion thus prepared is ideally produced a day ahead of coating. This allows small air bubbles introduced by stirring to escape. The blended polyurethane dispersions, or polyurethane dispersions without added thickeners, can then be coated on a coating system, i.e. an applicator system, with drying tunnel. Table 5 shows relevant parameters of the coating system and the drying tunnel. The PUD core layers produced, apart from surfactant, are free from process assistants and do not have a crystalline superstructure.

TABLE 5

Relevant parameters of the coating system and the drying tunnel

| | Applicator system | | | | Drying parameters | | | | | | | |
|---|---|---|---|---|---|---|---|---|---|---|---|---|
| | Hose | Coating roll | Doctor blade | v | T1 | T2 | T3 | T4 | T5 | T6 | T7 | T8 |
| | [°C] | [°C] | | [m/min] | [°C] | [°C] | [°C] | [°C] | [°C] | [°C] | [°C] | [°C] |
| PUD 1-6 | 20 | 20 | Comma | 20.0 | 90 | 90 | 110 | 130 | 150 | 150 | 150 | 45 |

Using two unwinders, either a PET carrier with release function or a prefabricated functional layer, i.e. PSA layer, on a PET carrier with release function is provided. It has proven to be useful to establish the desired layer thickness on PET carrier and then to switch to the prefabricated PSA layer and coat it directly. Before winding takes place, the second PSA layer, which has the same thickness as the first PSA layer, is then laminated to it using a regulatable contact-pressure roll.

The three-layer product thus produced is then wound up. The overall assembly of PU carrier and PSA layers is subjected to a further heat treatment step to optimize the tensile strength of the carrier, for improved anchoring and, if the PSA layers contain unexpanded microballoons, to foam the PSA layers. For this purpose the wound material is run through the same tunnel system with a temperature profile comprising three zones of 120° C./135° C./170° C. and at a belt speed of 6 m/min and is then wound up again. This produces the double-sided adhesive tapes having the PUD core layers PUD 1 to PUD 6.

### Results

Table 6 shows the mechanical properties of the adhesive tapes produced, and of the carriers they contain.

TABLE 6

Mechanical properties of adhesive tapes

| Ex. | Carrier | PSA | Adhesive tape | Carrier | | | Product | | | |
|---|---|---|---|---|---|---|---|---|---|---|
| | Variant | Designation (on each side) | Thickness | Elongation at break | Force at 400% | Ultimate tensile strength | Stripping force | Breaking force | DuPont z | Tearing at 90 ° |
| | | | [µm] | [%] | [N/m m²] | [N/mm²] | [N/mm ²] | [N/mm ²] | [mJ] | [%] |
| 1 (comp.) | TPU 1 | A | 150 | 687 | 20.4 | 34.0 | 9.5 | 14.6 | 554 | 100 |
| 2 (comp.) | PUD 1 | A | 150 | 967 | 3.5 | 31.6 | 7.3 | 13.7 | 723 | 50 |
| 3 (comp.) | PUD 2 | A | 150 | 901 | 3.8 | 35.7 | 7.5 | 14.0 | 715 | 50 |
| 4 | PUD 3 | A | 150 | 935 | 4.0 | 37.4 | 8.0 | 17.3 | 702 | 20 |
| 5 | PUD 4 | A | 150 | 927 | 4.1 | 45.0 | 7.7 | 20.7 | 698 | 0 |
| 6 | PUD 5 | A | 150 | 762 | 6.5 | 40.8 | 8.6 | 17.7 | 547 | 50 |
| 7 | PUD 6 | A | 150 | 949 | 3.9 | 38.9 | 7.4 | 16.7 | 708 | 0 |
| 8 (comp.) | PUD 6 | B | 150 | 949 | 3.9 | 38.9 | 10.2 | 13.5 | 589 | 100 |
| 9 | PUD 4 | C | 150 | 927 | 4.1 | 45.0 | 6.5 | 21.3 | 717 | 0 |

### Examples 2-7

The use, in accordance with the invention, of core layers (carriers) based on crosslinked PU carriers, including in particular those based on crosslinked PUD carriers, has emerged as being particularly advantageous, since it is possible here to set a particularly advantageous ratio between the force at 400% elongation, the F_{400%}, the typical extension range during the stripping operation in the component, relative to the ultimate tensile strength. This means that the force during the stripping operation, F_{400%}, is particularly low, in contrast to comparative example 1, with at the same time a high ultimate tensile strength, leading in turn to a very good tearing resistance. It is additionally possible to achieve greater shock properties with the carriers of the invention.

Surprisingly, and unforeseeably for the skilled person, it has been possible by using a crosslinker to increase the ultimate tensile strengths again significantly, with at the same time a low F_{400%} and with retention of the good shock properties, leading in turn to a further improved tearing resistance. Relative to comparative examples 2 and 3, then, in which no crosslinker was used, a further boost in the ultimate tensile strength was achieved, without any significant increase in the F_{400%}.

### Example 8 (Comparative - Comp.)

As Example 8 shows, the use of a styrene block copolymer-based PSA has proved to be advantageous especially in combination with the carrier crosslinked in accordance with the invention. The use of an acrylate-based PSA gave much poorer results particularly in terms of the tearing resistance.

### Example 9

As Example 9 shows, the use of a polymer blend-based PSA (polymer based on vinylaromatic block polymer and acrylate) has proved to be advantageous especially in combination with the carrier crosslinked in accordance with the invention.

### Test Methods

Unless stated otherwise, all measurements are conducted at 23° C. and 50% relative air humidity. The mechanical and adhesive data were ascertained as follows:

Tearing test by means of tensile tester, Zwick

In the tearing test, a first test plate of polyethylene and a second test plate of steel are used. The first test plate of polyethylene has been wrapped with a tesa® 67215 double-sided adhesive tape, to which a “battery film” has then been applied. The tesa® 67215 adhesive tape has a total thickness of 150 µm and contains a polyurethane carrier, on each side of which is disposed a foamed pressure sensitive adhesive layer based on vinylaromatic block copolymer. The “battery film” is an aluminium—laminated polymer film of thickness 88 µm from DNP — the film is typically used for production of lithium polymer batteries.

Specimens of width 8 mm and length 60 mm are diecut or lasered out of the adhesive tape to be examined. These specimens are stuck over a length of 50 mm onto the above-described battery film-wrapped first test plate of polyethylene, so as to leave a tab of length 10 mm. The tab is covered on either side with 36 µm of PET. The second test plate of steel, after cleaning with acetone and preconditioning for 1 to not more than 10 min at 23° C. and 50% relative air humidity, is stuck onto the reverse side of the bonded strip (i.e. specimen) such that the two test plates lie flush, i.e. congruent, with one another. A 4 kg roller is run 10 times over the composite on the reverse side of the steel plate (back and forth five times). After an attachment time of at least 4 h at 23° C. and 50% relative air humidity, the strips are stripped out of the adhesive join using the tab by means of a tensile tester (from Zwick) at a constant speed of 800 mm/minute at an angle of 90 ° via the edge of the battery film-wrapped first test plate of polyethylene. The test specimen is fixed here with an angle-adjustable adapter, and the tab is clamped perpendicularly in the middle of the clamping jaws.

Measurement is made at an angle of 90 °, during which the force continuously required for stripping out the sample is recorded by the tensile tester - called the stripping force Fₛₜᵣᵢₚ. The measurement is ended as soon as the sample has been stripped out completely between the two test plates or the sample has torn during the measurement. At least 6 measurements per specimen are conducted. The test conditions are 23° C. and 50% rel. air humidity.

### Reporting of Results

Tearing at 90° - the test is considered to be passed if less than 20% of the specimens tear during the stripping operation. Fₛₜᵣᵢₚ 90° [N/cm] - force required to strip the specimen out of the adhesive join at angle 90° (stripping force)

### Tensile Test by Means of Tensile Tester, Zwick

Strips of width 15 mm and having a length of about 150 mm are cut out of the sample to be examined (adhesive tape, i.e. carrier preferably provided with adhesive on either side, or plain carrier only) in longitudinal direction by means of a strip cutter or razor blade knife. The sample that had been preconditioned under the test conditions for 24 h is clamped at right angles in the middle of the clamping jaws with a clamped length of 10 mm and stretched at a speed of 800 mm/min until it tears. The break is supposed to occur in about the middle of the strip. If the break is close to the jaws (closer than 1 cm), the value should be rejected and a further strip should be tested instead. 5 measurements are conducted per sample variant. The test conditions are 23° C. and 50% rel. air humidity. The measurements are in accordance with EN ISO 527.

Reporting of results:

$$\begin{matrix}{\text{F}}_{\text{x\%}} \left[\text{N/cm}\right] , \left[{\text{N/mm}}^{2}\right] - \text{force at x\% elongation} \\ {\text{F}}_{\text{break}} \left[\text{N/cm}\right] , \left[{\text{N/mm}}^{2}\right] - \text{force at sample} \\ \text{tear/break} \left(\text{i} \text{.e} \text{. tear strength}\right) \\ \text{EB} \left[\%\right] - \text{elongation at break, i} \text{.e} \text{. percentage elongation at} \\ \text{sample tear/break}\end{matrix}$$

### Penetration Toughness, i.e. DuPont test in the z Plane

A square sample in the shape of a frame is cut out of the adhesive tape to be examined (external dimensions 33 mm x 33 mm; border width 2.0 mm; internal dimensions (window cut-out) 29 mm x 29 mm). This sample is stuck to a polycarbonate (PC) frame (external dimensions 45 mm x 45 mm; border width 10 mm; internal dimensions (window cut-out) 25 mm x 25 mm; thickness 3 mm). A PC window of 35 mm x 35 mm is stuck to the other side of the double-sided adhesive tape. The bonding of PC frame, adhesive tape frame and PC window is performed such that the geometric centres and the diagonals are each superimposed on one another (corner-to-corner). The bonding area is 248 mm². The bond is subjected to a pressure of 248 N for 5 s and stored under conditions of 23° C./50% relative humidity for 24 hours.

Immediately after the storage, the adhesive composite composed of PC frame, adhesive tape and PC window is braced by the protruding edges of the PC frame in a sample holder such that the composite is aligned horizontally. The PC frame rests flat on the protruding edges of the sample holders, such that the PC window is free-floating (held by the adhesive tape specimen) below the PC frame. The sample holder is then inserted centrally into the intended receptacle of the “DuPont Impact Tester”. The impact head of weight 150 g is used in such a way that the circular impact geometry with a diameter of 24 mm impacts centrally and flush on the face of the PC window freely accessible from above.

A weight having a mass of 150 g guided on two guide rods is allowed to drop vertically from a height of 5 cm onto the composite composed of sample holder, sample and impact head thus arranged (test conditions: 23° C., 50% relative humidity). The height from which the weight is dropped is increased in 5 cm steps until the impact energy introduced destroys the sample as a result of the penetration stress and the PC window parts from the PC frame.

In order to be able to compare experiments with different samples, the energy is calculated as follows:

$$\text{Energy E} \left[\text{J}\right] = \text{height} \left[\text{m}\right] * \text{mass of weight} \left[\text{kg}\right] * 9.81 {\text{kg/m*s}}^{2}$$

Five samples per product are tested, and the mean energy is reported as an index for penetration resistance.

### Shore A Hardness

The Shore A hardness of a sample is ascertained to ASTM D2240.

### Modulus at 100% Elongation, Elongation at Break

The modulus at 100% elongation, or elongation at break, of a sample is ascertained to DIN 53504.

### Thickness

The thickness of an adhesive layer can be determined by determining the thickness of a section, defined in terms of its length and width, of such an adhesive layer applied to a liner, minus the (known or separately determinable) thickness of a section of the same dimensions of the liner used. The thickness of the adhesive layer can be determined by means of commercial thickness measuring instruments (caliper test instruments) with accuracies of less than a 1 µm deviation. If variations in thickness are found, the average of measurements at at least three representative sites is reported, i.e. more particularly not measured at creases, folds, specks and the like.

Like the thickness for an adhesive layer as above, it is also possible to ascertain the thickness of an adhesive tape (adhesive strip) or of a carrier in an analogous manner by means of commercial thickness measuring instruments (caliper test instruments) with accuracies of less than a 1 µm deviation. If variations in thickness are found, the average of measurements at at least three representative sites is reported, i.e. more particularly not measured at creases, folds, specks and the like.

### Density

The density of the unfoamed and foamed adhesive layers is ascertained by forming the quotient of mass applied and thickness of the adhesive layer applied to a liner.

The mass applied can be determined by determining the mass of a section, defined in terms of its length and width, of such an adhesive layer applied to a liner, minus the (known or separately determinable) mass of a section of the same dimensions of the liner used.

The thickness of an adhesive layer can be determined by determining the thickness of a section, defined in terms of its length and width, of such an adhesive layer applied to a liner, minus the (known or separately determinable) thickness of a section of the same dimensions of the liner used. The thickness of the adhesive layer can be determined by means of commercial thickness measuring instruments (caliper test instruments) with accuracies of less than a 1 µm deviation. If variations in thickness are found, the average of measurements at at least three representative sites is reported, i.e. more particularly not measured at creases, folds, specks and the like.

The density of a carrier can be determined analogously.

### Molecular Weight Mₙ, M_{w}

The values reported for number-average molecular weight Mₙ and weight-average molecular weight M_{w} in this document relate to determination by gel permeation chromatography (GPC). The determination is carried out using a clear-filtered 100 µl sample (sample concentration 4 g/l). The eluent used is tetrahydrofuran with 0.1% by volume of trifluoroacetic acid. The measurement is made at 25° C. The precolumn used is a column of the PSS-SDV type, 5 µm, 10³ Å, 8.0 mm * 50 mm (values here and hereinafter in the following sequence: type, particle size, porosity, internal diameter * length; 1 Å = 10⁻¹⁰ m). For separation, a combination of the columns of the PSS-SDV type, 5 µm, 10³ Å and 10⁵ Å and 10⁶ Å each with 8.0 mm * 300 mm is used (columns from Polymer Standards Service; detection by means of Shodex RI71 differential refractometer). The flow rate is 1.0 ml per minute. In the case of polar molecules, for example the starting materials for the polyurethane, calibration is performed against PMMA standards (polymethyl methacrylate calibration), and otherwise against PS standards (polystyrene calibration).

### Tackifying Resin Softening Temperature

The tackifying resin softening temperature is carried out in accordance with the relevant methodology, which is known as Ring & Ball and is standardized according to ASTM E28.

### DACP

5.0 g of test substance (the tackifying resin sample to be examined) are weighed into a dry test tube, and 5.0 g of xylene (isomer mixture, CAS [1330-20-7], ≥ 98.5%, Sigma-Aldrich #320579 or comparable) are added. The test substance is dissolved at 130° C. and then cooled down to 80° C. Any xylene that escapes is made up for with fresh xylene, such that 5.0 g of xylene are present again. Subsequently, 5.0 g of diacetone alcohol (4-hydroxy-4-methyl-2-pentanone, CAS [123-42-2], 99%, Aldrich #H41544 or comparable) are added. The test tube is shaken until the test substance has dissolved completely. For this purpose, the solution is heated up to 100° C. The test tube containing the resin solution is then introduced into a Novomatics Chemotronic Cool cloud point measuring instrument and heated therein to 110° C. It is cooled down at a cooling rate of 1.0 K/min. The cloud point is detected optically. For this purpose, that temperature at which the turbidity of the solution is 70% is registered. The result is reported in °C. The lower the DACP value, the higher the polarity of the test substance.

1. Adhesive tape releasable by stretching, comprising:
a) at least one carrier based on a crosslinked polyurethane; and
b) at least one pressure sensitive adhesive layer based on vinylaromatic block copolymer.

2. Adhesive tape according to claim 1, wherein the polyurethane is a polyurethane prepared from extrusion (TPU) or a polyurethane prepared from dispersion (PUD).

3. Adhesive tape according to claim 1, wherein the polyurethane is crosslinked using a crosslinker based on aziridine, carbodiimide, melamine or isocyanate, more particularly a crosslinker based on isocyanate.

4. Adhesive tape according to claim 1, wherein the crosslinker is used in an amount of 0.5 to 10 wt%, preferably 1.0 to 8.0 wt% and more particularly 1.5 to 5 wt%, based in each case on the total weight of the carrier.

5. Adhesive tape according to claim 1, wherein the carrier is foamed, more particularly by microballoons.

6. Adhesive tape according to claim 1, wherein the vinylaromatic block copolymer is styrene-butadiene block copolymer.

7. Adhesive tape according to claim 1, wherein the pressure sensitive adhesive layer is foamed, more particularly by microballoons.

8. Adhesive tape according to claim 1, wherein the pressure sensitive adhesive layer is arranged on both sides on the carrier, and so the adhesive tape is a double-sided adhesive tape.

9. Adhesive tape according to claim 1, wherein the adhesive tape has a thickness of 30 to 350 µm, preferably 30 to 250 µm, more particularly 50 to 200 µm.

10. Adhesive tape according to claim 1, wherein the adhesive tape has a ratio of stripping force Fₛₜᵣᵢₚ to breaking force F_{break} of less than 60%, preferably less than 50%.

11. Method for producing an adhesive tape according to claim 1, wherein a crosslinkable polyurethane
(i) is extruded onto a temporary carrier and combined on at least one side, preferably both sides, with a pressure sensitive adhesive layer based on vinylaromatic block copolymer, or
(ii) is extruded onto a pressure sensitive adhesive layer based on vinylaromatic block copolymer to give a carrier, the carrier preferably being combined, on the side opposite the pressure sensitive adhesive layer, with a further pressure sensitive adhesive layer based on vinylaromatic block copolymer,
to give an adhesive tape.

12. Method for producing an adhesive tape according to claim 1, wherein a dispersion based on a polyurethane and a crosslinker
(i) is coated onto a temporary carrier or dried, and the resultant carrier is combined on at least one side, preferably both sides, with a pressure sensitive adhesive layer based on vinylaromatic block copolymer, or
(ii) is coated onto a pressure sensitive adhesive layer based on vinylaromatic block copolymer to give a carrier and dried, the carrier preferably being combined, on the side opposite the pressure sensitive adhesive layer, with a further pressure sensitive adhesive layer based on vinylaromatic block copolymer,
to give an adhesive tape.

13. Use of an adhesive tape according to claim 1 for bonding components in electronic devices.

14. Electronic device comprising a first component and a second component, which are bonded with an adhesive tape according to claim 1.

15. Adhesive tape according to claim 2, wherein the polyurethane is crosslinked using a crosslinker based on aziridine, carbodiimide, melamine or isocyanate, more particularly a crosslinker based on isocyanate.

16. Adhesive tape according to claim 2, wherein the crosslinker is used in an amount of 0.5 to 10 wt%, preferably 1.0 to 8.0 wt% and more particularly 1.5 to 5 wt%, based in each case on the total weight of the carrier.

17. Adhesive tape according to claim 3, wherein the crosslinker is used in an amount of 0.5 to 10 wt%, preferably 1.0 to 8.0 wt% and more particularly 1.5 to 5 wt%, based in each case on the total weight of the carrier.

18. Adhesive tape according to claim 2, wherein the carrier is foamed, more particularly by microballoons.

19. Adhesive tape according to claim 3, wherein the carrier is foamed, more particularly by microballoons.

20. Adhesive tape according to claim 4, wherein the carrier is foamed, more particularly by microballoons.
